(19) United States
(12) Patent Application Publication
(10) Pub. No.: US 2025/0142093 A1
(43) Pub. Date: May 1, 2025

(54) METHOD, APPARATUS, AND MEDIUM FOR VIDEO PROCESSING

(71) Applicants: Beijing Bytedance Network Technology Co., Ltd., Beijing (CN); Bytedance Inc., Los Angeles, CA (US)

(72) Inventors: Lei ZHAO, Beijing (CN); Kai ZHANG, Los Angeles, CA (US); Li ZHANG, Los Angeles, CA (US)

(21) Appl. No.: 19/009,881

(22) Filed: Jan. 3, 2025

Related U.S. Application Data
(63) Continuation of application No. PCT/CN2023/105144, filed on Jun. 30, 2023.

(30) Foreign Application Priority Data
Jul. 5, 2022 (WO) PCT/CN2022/104002

(51) Int. Cl. H04N 19/176; G06V 10/74; H04N 19/139; H04N 19/52

(52) U.S. Cl. CPC H04N 19/176; G06V 10/761; H04N 19/139; H04N 19/52

(57) ABSTRACT

Embodiments of the present disclosure provide a solution for video processing. A method for video processing is proposed. The method comprises: determining, for a conversion between a current video block of a video and a bitstream of the video, a plurality of co-located frames of the current video block, the current video block being in a current frame co-located with the plurality of co-located frame; and performing the conversion based on the plurality of co-located frames.

### CROSS REFERENCE TO RELATED APPLICATIONS

This application is a continuation of International Application No. PCT/CN2023/105144, filed on Jun. 30, 2023, which claims the benefit of International Application No. PCT/CN2022/104002 filed on Jul. 5, 2022. The entire contents of these applications are hereby incorporated by reference in their entireties.

### FIELD

Embodiments of the present disclosure relates generally to video coding techniques, and more particularly, to co-located frame-based video coding.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of conventional video coding techniques is generally very low, which is undesirable.

### SUMMARY

Embodiments of the present disclosure provide a solution for video processing.

In a first aspect, a method for video processing is proposed. The method comprises: determining, for a conversion between a current video block of a video and a bitstream of the video, a plurality of co-located frames of the current video block, the current video block being in a current frame co-located with the plurality of co-located frame; and performing the conversion based on the plurality of co-located frames. The method in accordance with the first aspect of the present disclosure performs the video coding process based on a plurality of co-located frames. In this way, temporal motion information can be utilized in video coding, and thus coding effectiveness and coding efficiency can be improved.

In a second aspect, another method for video processing is proposed. The method comprises: determining, for a conversion between a current video block of a video and a bitstream of the video, at least one motion shift list of the current video block based on at least one co-located frame of the current video block; determining a target motion shift associated a motion vector prediction (MVP) of the current video block based on the at least one motion shift list; and performing the conversion based on the target motion shift. The method in accordance with the second aspect of the present disclosure determines at least one motion shift list based on at least one co-located frame, and determine a target motion shift from the at least one motion shift list. In this way, more effective temporal motion information derivation can be achieved, and thus the coding effectiveness and coding efficiency can be improved.

In a third aspect, an apparatus for processing video data is proposed. The apparatus for processing video data comprises a processor and a non-transitory memory with instructions thereon. The instructions upon execution by the processor, cause the processor to perform a method in accordance with the first or second aspect of the present disclosure.

In a fourth aspect, a non-transitory computer-readable storage medium is proposed. The non-transitory computer-readable storage medium stores instructions that cause a processor to perform a method in accordance with the first or second aspect of the present disclosure.

In a fifth aspect, a non-transitory computer-readable recording medium is proposed. The non-transitory computer-readable recording medium stores a bitstream of a video which is generated by a method performed by a video processing apparatus. The method comprises: determining a plurality of co-located frames of a current video block of the video, the current video block being in a current frame co-located with the plurality of co-located frames; and generating the bitstream based on the plurality of co-located frames.

In a sixth aspect, a method for storing a bitstream of a video is proposed. The method comprises: determining a plurality of co-located frames of a current video block of the video, the current video block being in a current frame co-located with the plurality of co-located frames; generating the bitstream based on the plurality of co-located frames; and storing the bitstream in a non-transitory computer-readable recording medium.

In a seventh aspect, another non-transitory computer-readable recording medium is proposed. The non-transitory computer-readable recording medium stores a bitstream of a video which is generated by a method performed by a video processing apparatus. The method comprises: determining at least one motion shift list of the current video block based on at least one co-located frame of a current video block of the video; determining a target motion shift associated a motion vector prediction (MVP) of the current video block based on the at least one motion shift list; and generating the bitstream based on the target motion shift.

In an eighth aspect, a method for storing a bitstream of a video is proposed. The method comprises: determining at least one motion shift list of the current video block based on at least one co-located frame of a current video block of the video; determining a target motion shift associated a motion vector prediction (MVP) of the current video block based on the at least one motion shift list; generating the bitstream based on the target motion shift; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates positions of spatial and temporal neighboring blocks used in advanced motion vector prediction (AMVP) or merge candidate list constructure;

FIG. 5 illustrates an example diagram showing positions of non-adjacent candidate in ECM;

FIG. 6 illustrates an example diagram showing template matching performs on a search area around initial MV;

FIG. 7 illustrates an example diagram showing a template and the corresponding reference template;

FIG. 8 illustrates an example diagram showing template and reference template for block with sub-block motion using the motion information of the subblocks of current block;

FIG. 9 illustrates an example diagram showing an example of the positions for non-adjacent temporal motion vector prediction (TMVP) candidates;

FIG. 10 illustrates deriving sub-CU motion field obtained by applying a motion shift based on the neighboring motion information;

FIG. 11 illustrates an example diagram showing an example of the template;

FIG. 12 illustrates a flowchart of a method for video processing in accordance with some embodiments of the present disclosure;

FIG. 13 illustrates another flowchart of a method for video processing in accordance with some embodiments of the present disclosure; and

FIG. 14 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

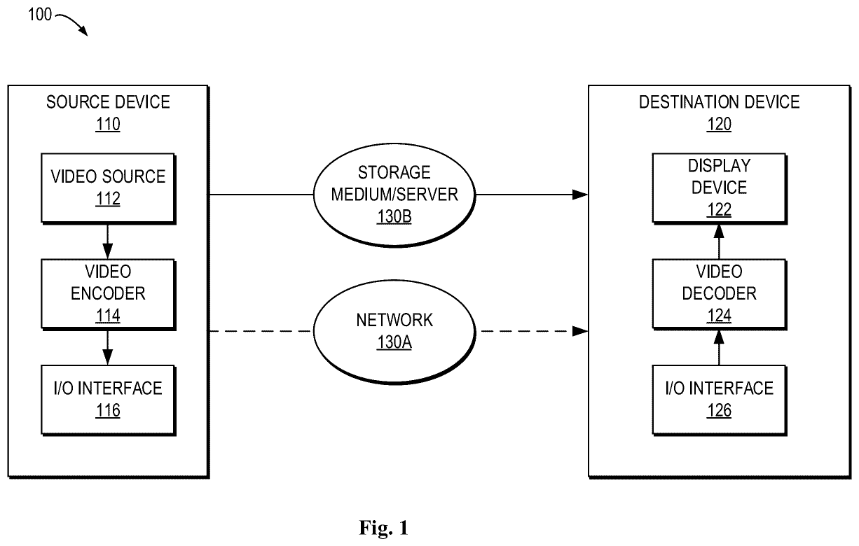

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

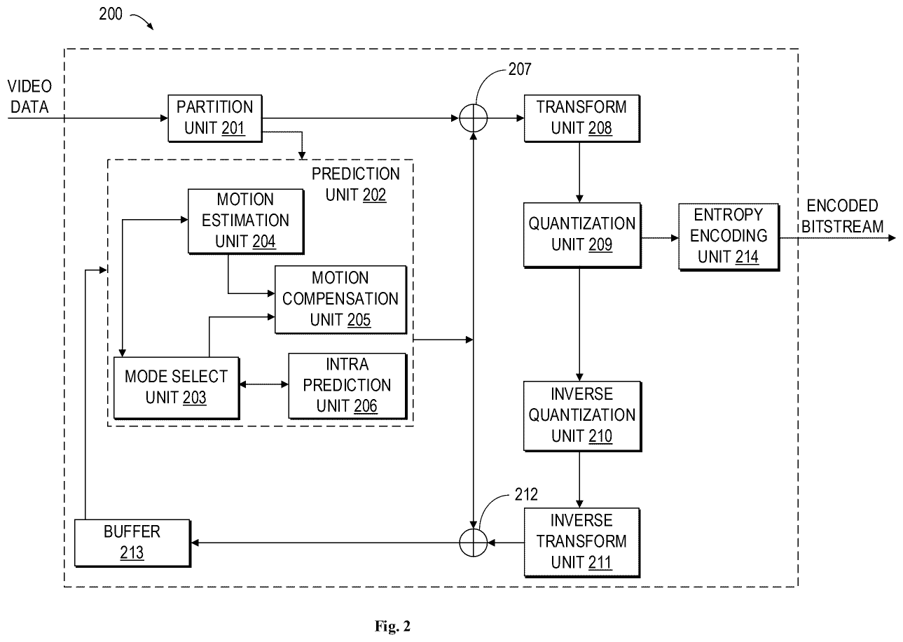

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a prediction unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the prediction unit 202 may include an intra block copy (IBC) unit. The IBC unit may perform prediction in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter prediction (CIIP) mode in which the prediction is based on an inter prediction signal and an intra prediction signal. The mode select unit 203 may also select a resolution for a motion vector (e.g., a sub-pixel or integer pixel precision) for the block in the case of inter-prediction.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector prediction (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the prediction unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

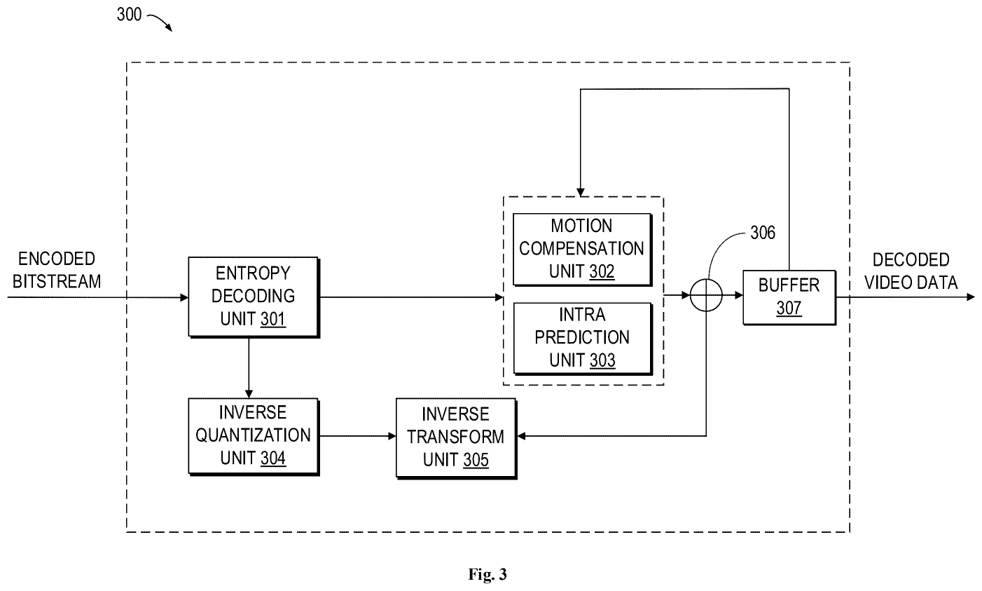

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra prediction and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Brief Summary

This disclosure is related to video coding technologies. Specifically, it is about motion vector prediction (MVP) construction method in video coding. The ideas may be applied individually or in various combination, to any video coding standard or non-standard video codec.

### 2. Introduction

The exponential increasing of multimedia data poses a critical challenge for video coding. To satisfy the increasing demands for more efficient compression technology, ITU-T and ISO/IEC have developed a series of video coding standards in the past decades. In particular, the ITU-T produced H.261 and H.263, ISO/IEC produced MPEG-1 and MPEG-4 visual, and the two organizations jointly developed the H.262/MPEG-2 Video, H.264/MPEG-4 Advanced Video Coding (AVC), H.265/HEVC and the latest VVC standards. Since H.262/MPEG-2, hybrid video coding framework is employed wherein in intra/inter prediction plus transform coding are utilized.

### 2.1. MVP in Video Coding

Inter prediction aims to remove the temporal redundancy between adjacent frames, which serves as an indispensable component in the hybrid video coding framework. Specifically, inter prediction makes use of the contents specified by motion vector (MV) as the predicted version of the current to-be-coded block, thus only residual signals and motion information are transmitted in the bitstream. To reduce the cost for MV signaling, motion vector prediction (MVP) came into being as an effective mechanism to convey motion information. Early strategies simply use the MV of a specified neighboring block or the median MV of neighboring blocks as MVP. In H.265/HEVC, competing mechanism was involved where the optimal MVP is selected from multiple candidates through rate distortion optimization (RDO). In particular, advanced MVP (AMVP) mode and merge mode are devised with different motion information signaling strategy. With the AMVP mode, a reference index, an MVP candidate index referring to an AMVP candidate list and motion vector difference (MVD) is signaled. Regarding the merge mode, only a merge index referring to a merge candidate list is signaled, and all the motion information associated with the merge candidate is inherited. Both AMVP mode and merge mode need to construct MVP candidate list, and the details of the construction process for these two modes are described as follows.

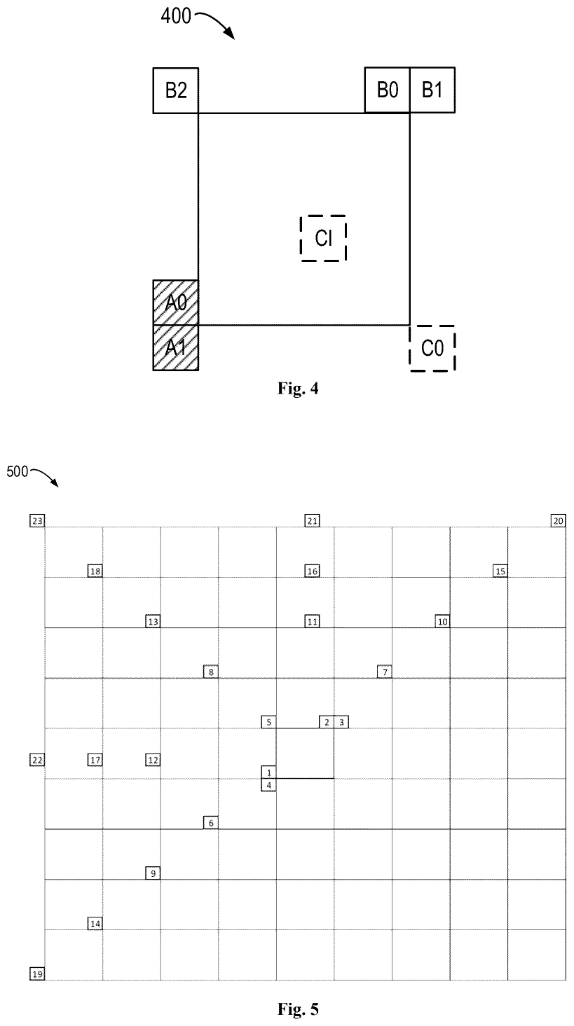

AMVP mode: AMVP exploits spatial-temporal correlation of motion vector with neighboring blocks, which is used for explicit transmission of motion parameters. For each reference picture list, a motion vector candidate list is constructed by firstly checking availability of left, above temporally neighboring positions, removing redundant candidates and adding zero vector to make the candidate list to be constant length. FIG. 4 illustrates an example diagram 400 showing positions of spatial and temporal neighboring blocks used in AMVP/merge candidate list construction. For spatial motion vector candidate derivation, two motion vector candidates are eventually derived based on motion vectors of blocks located in five different positions as depicted in FIG. 4. The five neighboring blocks located at B0, B1, B2, and A0, A1 are classified into two groups, where Group A includes the three above spatial neighboring blocks and Group B includes the two left spatial neighboring blocks. The two MV candidates are respectively derived with the first available candidate from Group A and Group B in a predefined order. For temporal motion vector candidate derivation, one motion vector candidate is derived based on two different co-located positions (bottom-right (C0) and central (C1)) checked in order, as depicted in FIG. 4. To avoid redundant MV candidates, duplicated motion vector candidates in the list are abandoned. If the number of potential candidates is smaller than two, additional zero motion vector candidates are added to the list.

Merge mode: Similar to AMVP mode, MVP candidate list for merge mode comprises of spatial and temporal candidates as well. For spatial motion vector candidate derivation, at most four candidates are selected with order A1, B1, B0, A0 and B2 after performing availability and redundant checking. For temporal merge candidate (TMVP) derivation, at most one candidate is selected from two temporal neighboring blocks (C0 and C1). When there are not enough merge candidates with spatial and temporal candidates, combined bi-predictive merge candidates and zero MV candidates are added to MVP candidate list. Once the number of available merge candidates reaches the signaled maximally allowed number, the merge candidate list construction process is terminated.

In VVC, the construction process for merge mode is further improved by introducing the history-based MVP (HMVP), which incorporates the motion information of previously coded blocks which may be far away from current block. In VVC, HMVP merge candidates are appended to merge list after the spatial MVP and TMVP. In this method, the motion information of a previously coded block is stored in a table and used as MVP for the current CU. The table with multiple HMVP candidates is maintained with first-in-first-out strategy during the encoding/decoding process. Whenever there is a non-subblock inter-coded CU, the associated motion information is added to the last entry of the table as a new HMVP candidate.

During the standardization of VVC, Non-adjacent MVP was proposed to facilitate better motion information derivation by exploiting the non-adjacent area. FIG. 5 illustrates an example diagram 500 showing positions of non-adjacent candidate in ECM. In ECM software, Non-adjacent MVP are inserted between TMVP and HMVP, where the distances between non-adjacent spatial candidates and current coding block are based on the width and height of current coding block as depicted in FIG. 5.

### 2.2. Interpolation Filters in VVC

In VVC, interpolations filters are used in both intra and inter coding process. Intra coding takes advantage of interpolation filters to generate fractional positions in angular prediction modes. In HEVC, a two-tap linear interpolation filter has been used to generate the intra prediction block in the directional prediction modes (i.e., excluding Planar and DC predictors). While in VVC, four-tap intra interpolation filters are utilized to improve the angular intra prediction accuracy. In particular, two sets of 4-tap interpolation filters are utilized in VVC intra coding, which are DCT-based interpolation filter (DCTIF) and smoothing interpolation filter (SIF). The DCTIF is constructed in the same way as the one used for chroma component motion compensation in both HEVC and VVC. The SIF is obtained by convolving the 2-tap linear interpolation filter with [1 2 1]/4 filter.

In VVC, the highest precision of explicitly signaled motion vectors is quarter-luma-sample. In some inter prediction modes such as the affine mode, motion vectors are derived at 1/16th-luma-sample precision and motion compensated prediction is performed at 1/16th-sample-precision. VVC allows different MVD precision ranging from 1/16-luma-sample to 4-luma-sample. For half-luma-sample precision, 6-tap interpolation filter is used. While for other fractional precisions, default 8-tap filter is used. Besides, the bilinear interpolation filter is used to generate the fractional samples for the searching process of decoder side motion vector refinement (DMVR) in VVC.

### 2.3. Template Matching Merge/AMVP Mode in ECM

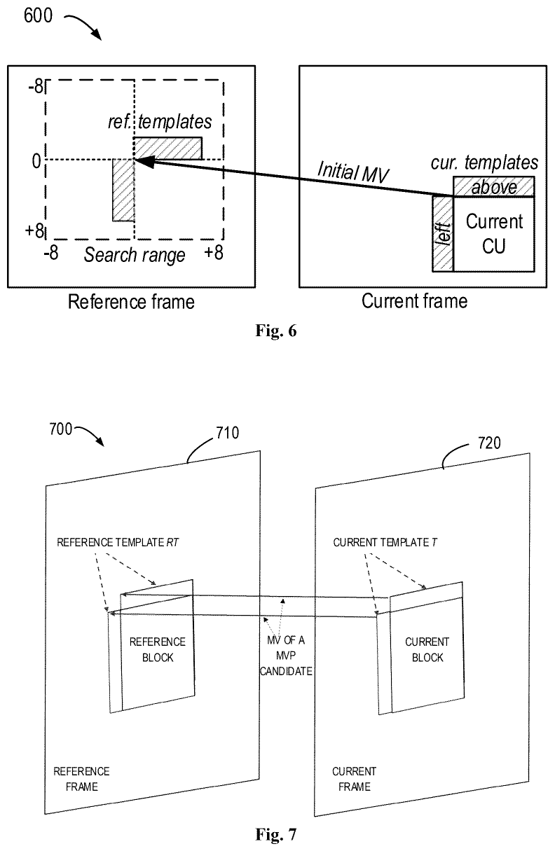

Template matching (TM) merge/AMVP mode is a decoder-side MV derivation method to refine the motion information of the current CU by finding the closest match between a template (i.e., top and/or left neighboring blocks of the current CU) in the current picture and a block (i.e., same size to the template) in a reference picture. FIG. 6 illustrates an example diagram 600 showing template matching performs on a search area around initial MV. As illustrated in FIG. 6, a better MV is to be searched around the initial motion of the current CU within a [−8, +8]-pel search range.

In AMVP mode, an MVP candidate is determined based on the template matching error to pick up the one which reaches the minimum difference between the current block and the reference block templates, and then TM performs only for this particular MVP candidate for MV refinement. TM refines this MVP candidate, starting from full-pel MVD precision (or 4-pel for 4-pel AMVR mode) within a [−8, +8]-pel search range by using iterative diamond search. The AMVP candidate may be further refined by using cross search with full-pel MVD precision (or 4-pel for 4-pel AMVR mode), followed sequentially by half-pel and quarter-pel ones depending on AMVR mode. This search process ensures that the MVP candidate still keeps the same MV precision as indicated by adaptive motion vector resolution (AMVR) mode after TM process.

In the merge mode, similar search method is applied to the merge candidate indicated by the merge index. TM merge may perform all the way down to 1/8-pel MVD precision or skipping those beyond half-pel MVD precision, depending on whether the alternative interpolation filter (that is used when AMVR is of half-pel mode) is used according to merged motion information. Besides, when TM mode is enabled, template matching may work as an independent process or an extra MV refinement process between block-based and subblock-based bilateral matching (BM) methods, depending on whether BM can be enabled or not according to its enabling condition check. When BM and TM are both enabled for a CU, the search process of TM stops at half-pel MVD precision and the resulted MVs are further refined by using the same model-based MVD derivation method as in DMVR.

### 2.4. Adaptive Reorder of Merge Candidates (ARMC)

Inspired by the spatial correlation between reconstructed neighboring pixels and the current coding block, adaptive reorder of merge candidates (ARMC) was proposed to refine the candidates order in a given candidate list. The underlying assumption is that the candidates with less template matching cost have higher probability to be chosen through RDO process, hence should be placed in front positions within the list to reduce the signaling cost.

The reordering method is applied to regular merge mode, template matching (TM) merge mode, and affine merge mode (excluding the SbTMVP candidate). For the TM merge mode, merge candidates are reordered before the refinement process.

After a merge candidate list is constructed, merge candidates are divided into several subgroups. The subgroup size is set to 5. Merge candidates in each subgroup are reordered ascendingly according to cost values based on template matching. For simplification, merge candidates in the last but not the first subgroup are not reordered.

FIG. 7 illustrates an example diagram 700 showing a template 720 and the corresponding reference template 710. The template matching cost is measured by the sum of absolute differences (SAD) between samples of a template of the current block and their corresponding reference template. The template 720 comprises a set of reconstructed samples neighboring to the current block, while reference template 710 is located by the same motion information of the current block, as illustrated FIG. 7. When a merge candidate utilizes bi-directional prediction, the reference samples of the template of the merge candidate are also generated by bi-prediction.

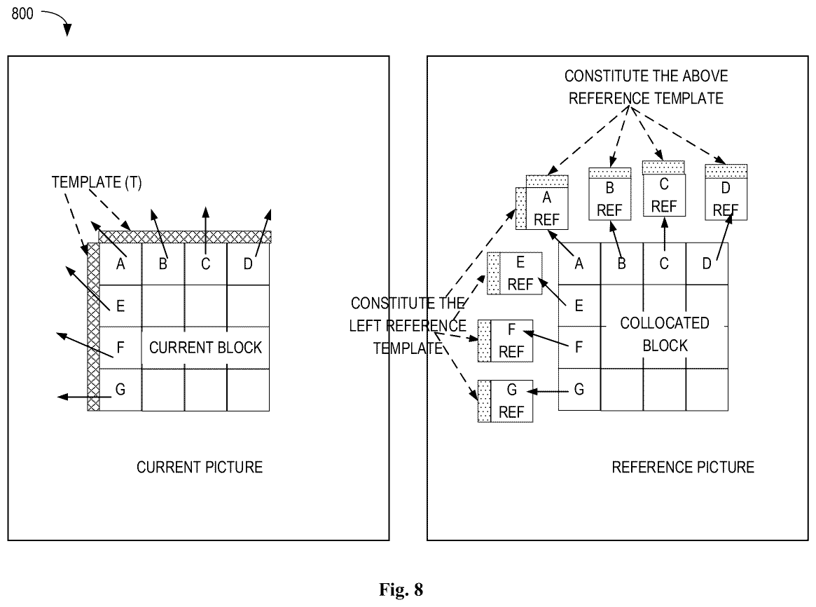

For subblock-based merge candidates with subblock size equal to Wsub * Hsub, the above template comprises several sub-templates with the size of Wsub×1, and the left template comprises several sub-templates with the size of 1× Hsub. FIG. 8 illustrates an example diagram 800 showing template and reference template for block with sub-block motion using the motion information of the subblocks of current block. As shown in FIG. 8. the motion information of the subblocks in the first row and the first column of current block is used to derive the reference samples of each sub-template.

### 2.5. Subblock-Based Temporal Motion Vector Prediction (SbTMVP)

VVC supports the subblock-based temporal motion vector prediction (SbTMVP) method. Similar to the TMVP, SbTMVP takes advantage of the motion field in the co-located picture to facilitate more precise MVP derivation.

The same co-located picture used by TMVP is used for SbTVMP. SbTMVP differs from TMVP mainly in two aspects. Firstly, SbTMVP enables sub-CU level motion prediction whereas TMVP predicts motion at CU level; Secondly, compared with TMVP that fetches the temporal MV from the co-located block in the co-located picture (the collocated block is the bottom-right or center block relative to the current CU), SbTMVP applies a motion shift before fetching the temporal motion information from the co-located picture, where the motion shift is obtained by re-using the MV from one of the spatial neighboring blocks of the current CU.

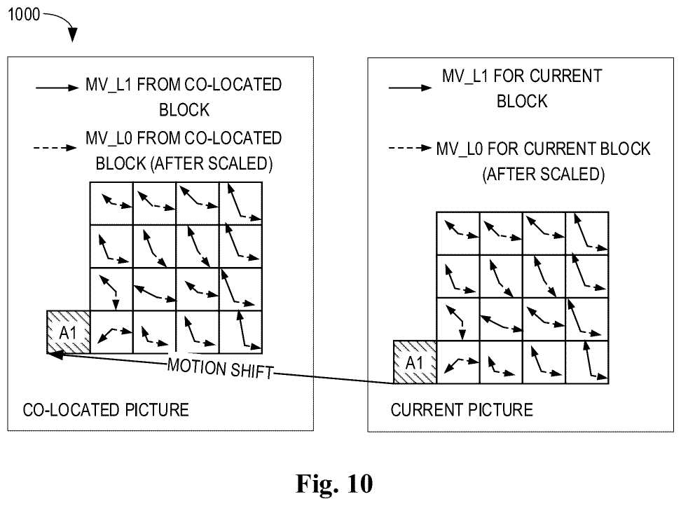

FIG. 10 illustrates a diagram 1000 illustrating deriving sub-CU motion field obtained by applying a motion shift based on the neighboring motion information. FIG. 10 illustrates the derivation process of the sub-block level motion field for SbTMVP. In particular, the motion information of left-bottom sub-block A1 is firstly fetched, if either of the MVs in reference list0 and list1 points to the co-located frame, then the corresponding MV will be identified as motion shift. Otherwise, zero mv will be used as motion shift.

Once the motion shift is determined, the specified regions in the co-located frame is employed to derive sub-block level motion field. Assuming A1' motion is used as motion shift as depicted in FIG. 10. Then for each sub-CU, the motion information of its corresponding block (the smallest motion grid that covers the center sample) in the collocated picture is fetched to provide motion information, where MV scale operation is firstly performed to align the reference frames of the temporal motion vectors to those of the current CU.

In VVC and ECM, in addition to CU level MVP candidate list, a sub-CU level MVP candidate list is also constructed to provide more precise motion prediction for the current CU, which comprises the motion fields produced by both SbTMVP and AFFINE methods. In particular, only one SbTMVP candidate is included and is always placed in the first entry of the constructed sub-CU level MVP candidate list, whereas multiple AFFINE candidates are included in the list after performing template matching-based reordering, where those with smaller costs are placed in fronter positions.

2.6. Co-located frame and TMVP Candidate List in ECM-5.0

In ECM-5.0, only one co-located frame is utilized to provide TMVP that are required in the MVP list construction process, which is derived from the reference frame list. In particular, if only one reference list is maintained in the coding process, then the reference frame with index zero is utilized as co-located frame. Otherwise, if the to-be-coded frame has two reference frame lists as in random access and low-delay B configurations, the quantization parameter (QP) value of the reference frame with index zero in both lists are compared, and the one with larger QP will be chosen as co-located frame for the current frame.

For regular merge and adaptive DMVR modes in ECM-5.0, the derivation of the TMVP in the ultimate MVP list is further optimized, where TMVP candidate list is first constructed to include the TMVPs that locate in different positions within the co-located frame. Specifically, both adjacent and non-adjacent positions in the right-bottom direction are used to provided multiple TMVP candidates. When TMVP list is constructed, templated matching cost is calculated for each candidate and the list is accordingly sorted in a descending order of such cost. Finally, the candidate with the least template matching cost will be inserted in the ultimate MVP list. Regarding TMVP derivation for AMVP and AFFINE mode, no TMVP list is needed and only one TMVP is derived based on two different co-located positions (bottom-right (CO) and central (C1)) checked in order.

### 2.7. Enhanced MVP Candidate Derivation (EMCD)

EMCD based on template matching cost reordering has been proposed. Instead of constructing the MVP list based on a predefined traversing order, an optimized MVP selecting approach by taking advantage of the matching cost in the reconstructed template region, such that more appropriate candidates are included in the list is investigated. It should be noted that the proposed strategy for MVP list construction can be utilized in normal merge and AMVP list construction process and can also be easily extended to other modules that require MVP derivation, e.g., merge with motion vector difference (MMVD), Affine motion compensation, Subblock-based temporal motion vector prediction (SbTMVP) and so on.

### Non-Adjacent TMVP

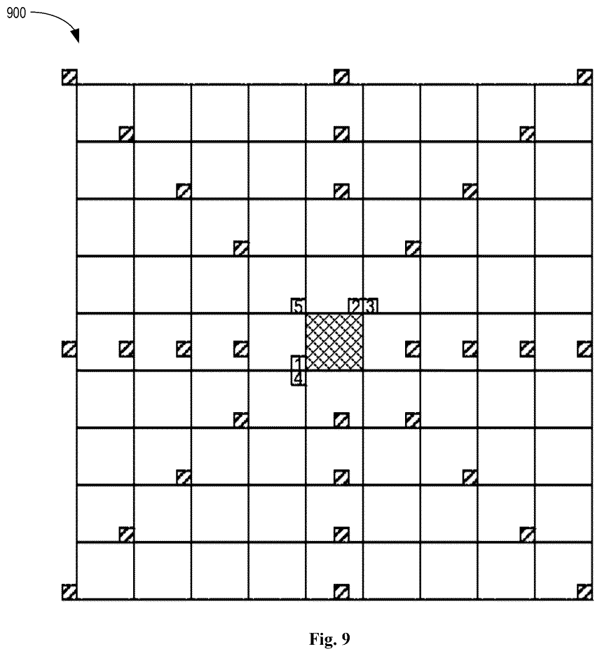

1. It is proposed to make use of the TMVP in a non-adjacent area to further improve the effectiveness of the MVP list.
a) In one example, a non-adjacent area may be any block (such as 4×4 block) in a reference picture and neither inside nor adjacent to the collocated block in the reference picture of the current block.
b) FIG. 9 illustrates an example diagram 900 showing an example of the positions for non-adjacent TMVP candidates. In one example, the positions of the non-adjacent TMVP candidates are illustrated in FIG. 9, where black blocks represent the potential non-adjacent TMVP positions. It should be noted that this figure only provides an example for non-adjacent TMVP, and the positions are not limited to the indicated blocks. In other cases, non-adjacent TMVP may locate in any other positions in one or more reconstructed frames.
   2. The maximum allowed non-adjacent TMVP number in the MVP list may be signaled in the bitstream.
a) In one example, the maximum allowed number can be signaled in SPS or PPS.
   3. The non-adjacent TMVP candidates may locate in the nearest reconstructed frame, but it may also locate in other reconstructed frames.
a) Alternatively, non-adjacent TMVP candidates may locate in the collocated picture.
b) Alternatively, it is signaled in which picture non-adjacent TMVP candidates may locate.
   4. Non-adjacent TMVP candidates may locate in multiple reference pictures.
   5. The distances between a non-adjacent area associated with a TMVP candidate and current coding block may be related to the property of the current block.
a) In one example, the distances depend on the width and height of current coding block.
b) In other cases, the distances may be signaled in the bitstream as a constant.

### Definition of the Template

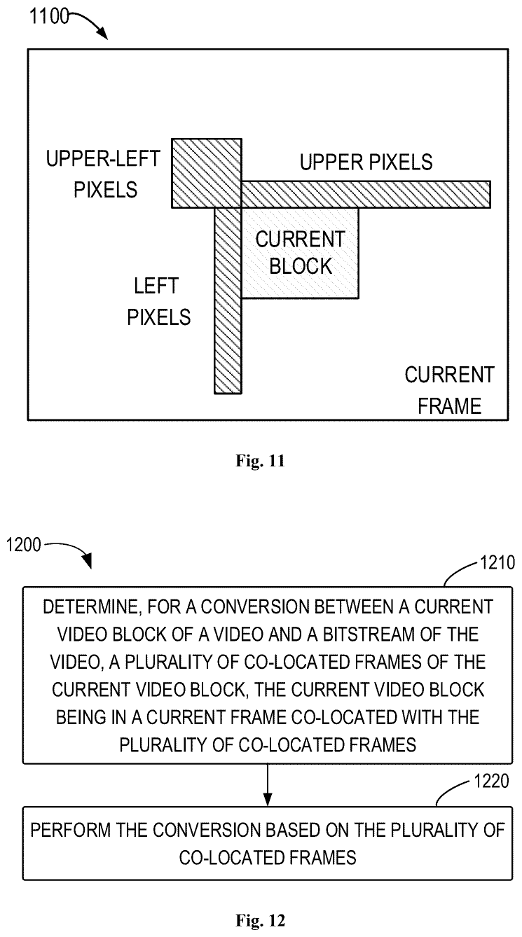

6. Template represents the reconstructed region that can be used to estimate the priority of an MVP candidate, which may locate in different positions with variable shape. FIG. 11 illustrates an example diagram 1100 showing an example of the template.
a) In one example, a template may comprise of the reconstructed regions in three positions, which are upper pixels, left pixels and upper-left pixels, as presented in FIG. 11.
b) It should be noted that the template may not necessarily be in rectangular shape, it can be in arbitrary shape, e.g., triangle or polygon.
c) In one example, the template regions may be utilized either in separate or combined manner.
d) A template may only comprise samples from one component such as luma, or from multiple components such as luma and chroma.
   7. The template may not necessarily locate in the current frame, it may locate in any other reconstructed frame.
   8. In one example, a reference template region with the same shape as the template of the current block may be located with an MV, as shown in FIG. 7.
   9. In one example, the template may not necessarily locate in adjacent area, it may locate in non-adjacent areas that are far away from the current block.
   10. In one example, a template may not necessarily contain all the pixels in a certain region, it may contain part of the pixels in a region.

### Template Matching Based MVP Candidate Ordering

11. In embodiments of the present disclosure, template matching cost associated with a certain MVP candidate serves as a measurement to evaluate the consistency of this candidate and true motion information. Based on this measurement, a more efficient order is generated by sorting the priority of each MVP candidate.
a) In one example, the template matching cost C is evaluated with mean of square error (MSE), as calculated below:

$$C = \frac{{\sum }_{( i , j ) ∈ T} {( T ( i , j ) - R T ( i , j ) )}^{2}}{N} ,$$

where T represents the template region, RT represents the corresponding reference template region specified by the MV within MVP candidate (FIG. 7), N is the pixel number within the template.
b) In one example, the template matching cost can be evaluated with sum of square error (SSE), sum of absolute difference (SAD), sum of absolute transformed difference (SATD) or any other criterion that can measure the difference between two regions.
   12. All the MVP candidates are sorted in an ascending order regarding the corresponding template matching cost, and the MVP list is constructed by traversing the candidates in the sorted order until the MVP amount reaches the maximum allowed number. In this way, a candidate with a lower matching cost has a higher priority to be included in the ultimate MVP list.
a) In one example, the sorting process may be conducted towards all the MVP candidates.
b) Alternatively, this process may also be applied to part of candidates, e.g., non-adjacent MVP candidates, HMVP candidates or any other group of candidates.
c) Alternatively, furthermore, which categories of MVP candidates (e.g., non-adjacent MVP candidates are belonging to one category, HMVP candidates are belonging to another category) and/or what kinds of group of candidates should be reordered may be dependent on the decoded information, e.g., block dimension/coding methods (e.g., CIIP/MMVD) and/or how many available MVP candidates before being reordered for a given kind/group.
   1. In one example, the sorting process may be conducted for a joint group which contains only one category of MVP candidates.
   2. In one example, the sorting process may be conducted for a joint group which contains more than one category of MVP candidates.
      a) In one example, for a first coding method (e.g., regular/CIIP/MMVD/GPM/TPM/subblock merge mode), the sorting process can be conducted for a joint group of non-adjacent MVP, non-adjacent TMVP and HMVP candidates. For a second coding method (e.g., the template matching merge mode), the sorting process can be conducted for a joint group of adjacent MVP, non-adjacent TMVP, non-adjacent MVP and HMVP candidates.
      b) Alternatively, for a first coding method (e.g., regular/CIIP/MMVD/GPM/TPM/subblock merge mode), the sorting process can be conducted for a joint group of non-adjacent MVP and HMVP candidates. For a second coding method (e.g., the template matching merge mode), the sorting process can be conducted for a joint group of adjacent MVP, non-adjacent MVP and HMVP candidates.
   3. In one example, the sorting process may be conducted for a joint group which contains partial of available MVP candidates within the categories.
      a) In one example, for regular/CIIP/MMVD/TM/GPM/TPM/subblock merge mode, or for regular/affine AMVP mode, the sorting process can be conducted for a joint group of all or partial candidates from one or multiple categories.
   4. In above examples, the category may be:
      i. adjacent neighboring MVPs;
      ii. adjacent neighboring MVPs at specific location(s);
      iii. TMVP MVPs;
      iv. HMVP MVPs;
      v. Non-adjacent MVPs;
      vi. Constructed MVPs (such as pairwise MVPs);
      vii. Inherited affine MV candidates;
      viii. Constructed affine MV candidates;
      ix. SbTMVP candidates.
d) In one example, this process may be conducted multiple times on different set of candidates.
   1. For example, a set of candidates (such as non-adjacent MVP candidates) may be sorted, and the N non-adjacent MVP candidates with the lowest costs may be put into the candidate list. After the whole candidate list is constructed, the costs of candidates in the list may be calculated and the candidates may be reordered based on the costs.
      13. It is proposed that the MVP list construction process may involve both reordering of a single group/category and a joint group which contains candidates from more than one category.
a) In one example, the joint group may include candidates from a first and a second category.
   1. Alternatively, furthermore, the first and second category may be defined as the non-adjacent MVP category and HMVP category.
   2. Alternatively, furthermore, the first and second category may be defined as the non-adjacent MVP category and HMVP category, and the joint group may include candidates from a third category, e.g., TMVP category.
b) In one example, the single group may include candidates from a fourth category.
   1. Alternatively, furthermore, the fourth category may be defined as the adjacent MVP category.
      14. Multiple groups or categories can be respectively reordered to construct MVP list.
a) In one example, only one single group (all the candidates belong to one category, e.g. adjacent MVP, non-adjacent MVP, HMVP, etc.) is built and reordered in MVP list construction process.
b) In one example, only one joint group (contains partial or all the candidates from multiple categories) is built and reordered in MVP list construction process.
c) In one example, more than one group (regardless of single or joint) are respectively built and reordered in MVP list construction process.
   1. In one example, two or more single groups are respectively built and reordered in MVP list construction process.
   2. In one example, two or more joint groups are respectively built and reordered in MVP list construction process.
   3. In one example, one or multiple single groups and one or multiple joint groups are respectively reordered in MVP list construction process.
      a) In one example, one single groups and one joint groups are respectively built and reordered to construct MVP list.
      b) In one example, one single groups and multiple joint groups are respectively built and reordered to construct MVP list.
      c) In one example, multiple single groups and one joint groups are respectively built and reordered to construct MVP list.
      d) In one example, multiple single groups and multiple joint groups are respectively built and reordered to construct MVP list.
      d) In one example, candidates that belong to the same category can be divided into different groups, and are respectively reordered in the corresponding groups.
e) In one example, only partial candidates in specific category are put into the single or joint group, and rest candidates in this category are not reordered.
f) In above examples, the category may be:
   1. adjacent neighboring MVPs;
   2. adjacent neighboring MVPs at specific location(s);
   3. TMVP MVPs;
   4. HMVP MVPs;
   5. Non-adjacent MVPs;
   6. Constructed MVPs (such as pairwise MVPs);
   7. Inherited affine MV candidates;
   8. Constructed affine MV candidates;
   9. SbTMVP candidates.
      15. The proposed sorting method can also be applied to AMVP mode.
a) In one example, the MVP in AMVP mode can be extended with non-adjacent MVP, non-adjacent TMVP and HMVP.
b) In one example, MVP list for AMVP mode comprises K candidates, which are selected from M categories, such as adjacent MVPs, non-adjacent MVPs, non-adjacent TMVPs and HMVPs wherein K and M are integers.
   1. In one example, K could be smaller than M, or equal to M or greater than M.
   2. In one example, one candidate is selected from each category.
   3. Alternatively, for a given category, no candidate is selected.
   4. Alternatively, for a given category, more than 1 candidate is selected.
   5. In one example, MVP list for AMVP mode comprises 4 candidates, which are selected from adjacent MVPs, non-adjacent MVPs, non-adjacent TMVPs and HMVPs.
   6. In one example, each category of MVP candidates is respectively sorted with template matching cost, and the one with minimum cost in the corresponding category is selected and included in the MVP list.
   7. Alternatively, adjacent MVP candidates and a joint group of non-adjacent MVP, non-adjacent TMVP together with HMVP candidates are respectively sorted with template matching cost. One adjacent candidate with the minimum template matching cost is selected from adjacent MVP candidates, and three other candidates are derived by traversing the candidates in the joint group in an ascending order of template matching cost.
   8. In one example, MVP list for AMVP mode comprises 2 candidates, one comes from adjacent MVP and the other comes from non-adjacent MVP, non-adjacent TMVP or HMVP. In particular, adjacent MVP candidates and a joint group of non-adjacent MVP, non-adjacent TMVP together with HMVP are respectively sorted with template matching cost, and the one with minimum cost in the corresponding category (or group) is included in the MVP list.
      16. The proposed sorting methods may be applied to other coding methods, e.g., for constructing a block vector list of IBC coded blocks.
a) In one example, it may be used for affine coded blocks.
b) Alternatively, furthermore, how to define the template cost may be dependent on the coding methods.
   17. The usage of this method may be controlled with different coding level syntax, including but not limit to one or multiple of PU, CU, CTU, slice, picture, sequence levels.
   18. On how to insert sorted candidates to MVP list.
a) In one example, which candidates within the joint or separate group are included into MVP list depends on the sorting results of template matching cost.
b) In one example, whether put the candidates within the separate or joint group into MVP list depends on the sorting results of template matching cost.
c) In one example, how many candidates within the separate or joint group are included into MVP list depends on the sorting results of template matching cost.
   1. In one example, only one candidate with the smallest template matching cost is included into MVP list.
   2. In one group, top-N candidates regarding the template matching cost in an ascending order are included into MVP list, where N is the maximum allowed candidate number can be inserted into MVP list in the corresponding single or joint group.
      a) In one example, N can be a predefined constant for each single or joint group.
      b) Alternatively, N can be adaptively derived based on the template matching cost within the single or joint group.
      c) Alternatively, N can be signaled in the bitstream.
      d) In one example, different candidate groups share a same N value.
      e) Alternatively, different single or joint groups may have different N value.
         Pruning for MVP Candidates 19. The pruning for MVP candidates aims to increase the diversity within the MVP list, which can be realized by using appropriate threshold TH.
a) In one example, if the two candidates point to same reference frame, they may both be included to MVP list only if the absolute difference between the corresponding X and Y components are either or both larger (or no smaller) than TH.
   20. The pruning threshold can be signaled in the bitstream.
b) In one example, the pruning threshold can be signaled either in PU, CU, CTU or slice level.
   21. The pruning threshold may depend on the characteristics of the current block.
c) In one example, the threshold may be derived by analyzing the diversity among the candidates.
d) In one example, the optimal threshold can be derived through RDO.
   22. The pruning for MVP candidates may be firstly performed within a single or joint group before being sorted.
a) Alternatively, furthermore, for two MVP candidates belonging to two different groups or one belonging to a joint group and the other doesn't, pruning among these two MVP candidates are not performed before sorting.
b) Alternatively, furthermore, pruning among multiple groups may be applied after the sorting.
   23. The pruning for MVP candidates may be firstly performed among multiple groups and the sorting may be further applied to one or multiple single/joint groups.
a) Alternatively, an MVP list may be firstly constructed with pruning among available MVP candidates involved. Afterwards, sorting may be further applied to reorder one or multiple single/joint groups.
b) Alternatively, furthermore, for two MVP candidates belonging to two different groups or one belonging to a joint group and the other doesn't, pruning among these two MVP candidates is performed before sorting.
   Interaction with Other Coding Tools
   24. After an MVP list with above sorting methods applied, the Adaptive Reordering Merge Candidates (ARMC) process may be further applied.
a) In one example, the template costs used in the sorting process during MVP list construction may be further utilized in the ARMC.
b) In another example, different template costs may be used in the sorting process and ARMC process.
   1. In one example, the template may be different for the sorting and ARMC process.
   25. Whether to and/how to enable the sorting process may be dependent on the coding tool.
a) In one example, when a certain tool (e.g., MMVD or affine mode) is enabled for a block, the sorting is disabled.
b) In one example, for two different tools, the sorting rules may be different (e.g., being applied to different groups or different template settings).

### 2.8. Simplifications for Template Matching Based Video Coding Methods

The template matching based video coding methods are optimized in two aspects. Firstly, reference template derivation process is revised that the interpolation process in the prediction block generation process is replaced by different ways. Secondly, several fast strategies are devised to speedup the tools related to template matching. It should be noted that the proposed methods can be utilized in ARMC, EMCD and template matching MV refinement, and can also be easily extended to other potential utilizations that require template matching process, e.g., template matching based candidates reorder for merge with motion vector difference (MMVD), Affine motion compensation, Subblock-based temporal motion vector prediction (SbTMVP) and so on. In yet another example, the proposed methods could be applied to other coding tools that requires motion information refinement processes, e.g., bilateral matching-based coding tools.

The detailed embodiments below should be considered as examples to explain general concepts. These embodiments should not be interpreted in a narrow way. Furthermore, these embodiments can be combined in any manner. Combination between embodiments of the present disclosure and others are also applicable.

1. It is proposed to replace the interpolation filtering process involved in the motion compensation process of an inter prediction signal generation process by other ways in the reference template generation process.
a) It is proposed to exclude interpolation filtering process to generate a reference template even the motion vector point to fractional positions.
   i. In one example, it is proposed to use an integer precision to generate a reference template.
   ii. In one example, if a motion vector points to a fractional position, it is rounded to be an integer MV firstly.
      1. In one example, the fractional position is rounded toward zero (that is, a negative motion vector predictor is rounded toward positive infinity and a positive motion vector predictor is rounded toward negative infinity).
      2. In one example, the round step may larger than 1.
b) It is proposed to use a different interpolation filter to generate reference templates for motion vectors pointing to fractional positions.
   i. In one example, a simplified interpolation filter may be applied.
      1. In one example, the simplified interpolation filter can be 2-tap bilinear, alternatively, it can also be 4-tap, 6-tap or 8-tap filter that belongs to DCT, DST, Lanczos or any other interpolation types.
   ii. In one example, a more complex interpolation filter (e.g., with longer filter taps) may be applied.
c) The above methods may be used to reorder the merge candidates for template matching merge mode.
   i. In one example, integer precision can be used in ARMC, EMCD, LIC and any other potential scenarios,
   ii. The above methods may be used to reorder the candidates for regular merge mode.
      1. In one example, integer precision can be used to reorder the candidates for regular merge mode.
d) In one example, whether to use above methods (e.g., integer precision, different interpolation filters) or not and/or how to use above methods can be signaled in the bitstream or determined on-the-fly according to decoded information.
   i. In one example, which method to be applied may be dependent on the coding tool.
   ii. In one example, which method to be applied may be dependent on block dimension.
   iii. In one example, integer precision may be used for a given color component (e.g., luma only).
   iv. Alternatively, integer precision may be used all of the three components.
      2. Whether to and/or how to perform EMCD may be based on the maximum allowed candidate number within candidate list and/or available candidate number before being added to a candidate list.
a) In one example, assuming the number of available candidates (valid candidates that can be used to build candidate list) is NAVAL, and the maximum allowed candidate number is NMAX (that is, at most NMAX candidates can be included into the ultimate merge list), then EMCD is enabled only when NAVAL-NMAX larger than a constant or adaptively derived threshold T.
   3. It is proposed to organize the available merge candidates into subgroups.
a) In one example, the available candidates can be categorized into subgroups, each subgroup contains a fixed or adaptively derived number of candidates, and each subgroup selects a fix number of candidates into the list. In the decoder side, only the candidates within a chosen subgroup need to be reordered.
b) In one example, the candidates can be categorized into subgroups according to the candidates' category, such as non-adjacent MVP, temporal MVP (TMVP) or HMVP, etc.
   4. It is proposed that a piece of information calculated by a first coding tool utilizing at least one template cost may be reused by a second coding tool utilizing at least one template cost.
a) It is proposed to build a unified storage shared by ARMC, EMCD and any other potential tools to store the information of each merge candidate.
b) In one example, this storage can be a map, table or other data structure.
c) In one example, the stored information can be template matching cost.
d) In one example, EMCD first traverses all the MVs associated with the available candidates and store the corresponding information (including but not limited to template matching cost) in this storage. Then ARMC and/or other potential tools can simply access the needed information from this shared storage without performing repeating calculation.

### 3. Problems

1) Existing MVP candidate list construction methods normally use a uniform threshold in the candidate pruning process, which does not fully exploit the distinct importance of potential MVP candidates, leading to low-efficiency of the constructed MVP list.
2) In existing MVP candidate list construction methods, adjacent MVPs have the highest priority to be included in the ultimate list. However, an adjacent MVP may not always be better than other candidates, i.e., non-adjacent MVP, HMVP, etc. Accordingly, it is beneficial to decrease the priority of those adjacent candidates with low-quality.

3) In existing video coding standards, the temporal motion information has not been fully token advantage of due to the fact that only one co-located frame is used. Multiple co-located frames are highly desired to facilitate inter coding by providing more effective MVPs.

4) In existing video coding standards, the temporal motion vector predictions for certain coding tools, e.g. AMVP, AFFINE and so on, are derived by fetching the motion information from some pre-defined positions in the co-located frame. And similar strategy is also applied to SbTMVP method, where the motion information from a fixed neighbouring position is used as the motion shift. Such mechanical designs are far from optimal as they can hardly ensure the consistency between the trajectory of the pre-defined positions and current CU. Flexible strategies are therefore highly desired to facilitate more effective temporal motion information derivation.

### 4. Detailed Solutions

In this disclosure, an optimized MVP list derivation method based on template matching cost ordering is proposed. Instead of constructing the MVP list based on a predefined traversing order, an optimized MVP selecting approach by taking advantage of the matching cost in the reconstructed template region, such that more appropriate candidates are included in the list is investigated.

It should be noted that the proposed strategy for MVP list construction can be utilized in normal merge and AMVP list construction process and can also be easily extended to other modules that require MVP derivation, e.g., merge with motion vector difference (MMVD), Affine motion compensation, Subblock-based temporal motion vector prediction (SbTMVP) and so on.

In the following discussion, category represents the belongingness of an MVP candidate, e.g., non-adjacent MVP candidates belong to one category, HMVP candidates belonging to another category. A group denotes an MVP candidate set which contains one or multiple MVP candidates. In one example, a single group denotes an MVP candidate set in which all the candidates belong to one category, e.g. adjacent MVP, non-adjacent MVP, HMVP, etc. In another example, a joint group denotes an MVP candidate set which contains candidates from multiple categories. list can either be MVP candidate MVP candidate list, TMVP candidate list, motion shift candidate list or sub-CU level MVP candidate list, where MVP candidate list represents a group of MVP candidates that can be selected as MVP in video coding process. TMVP candidate list represent a group of TMVP where each candidate within the group has the potential to be selected as the candidate in MVP candidate list. Motion shift candidate list represents a group of MV candidates that point to the collocated frame in video coding process. Sub-CU level MVP candidate list represent a group of motion candidates that provide sub-CU level motion fields, including SbTMVP candidates, AFFINE candidates and so on.

The detailed embodiments below should be considered as examples to explain general concepts. These embodiments should not be interpreted in a narrow way. Furthermore, these embodiments can be combined in any manner. Combination between this disclosure and others are also applicable.

1. Multiple thresholds to determine whether a candidate could be added to a candidate list may be utilized in the candidate pruning process.
a) A threshold may be used to determine whether a potential candidate can be put into a candidate list.
   i. For example, if the absolute difference of at least one component of the MV of the potential candidate and that of a candidate existing in the candidate list is smaller than a threshold, the potential candidate is not put into the list.
   ii. For example, if the absolute difference of all components of the MV of the potential candidate and that of a candidate existing in the candidate list is smaller than a threshold, the potential candidate is not put into the list.
b) In one example, the candidate is an MVP candidate, the candidate pruning process is the MVP candidate pruning process, and the candidate list is a motion candidates list.
   i. In one example, the motion candidate list is a merge candidate list.
   ii. In one example, the motion candidate list is a AMVP candidate list.
   iii. In one example, the motion candidate list is an extend merge or AMVP list, such as sub-block merge candidate list, affine merge candidate list, MMVD list, GPM list, template matching merge list, biliteral matching merge list etc.
c) In one example, the pruning thresholds may be different for two groups, where the group can be either a single group (containing only one category of candidates) or a joint group (containing at least two categories of candidates).
d) Alternatively, only one threshold is used for all potential MVP candidates regardless of category and/or groups.
e) In one example, N (e.g., N=2) thresholds are used in the pruning process.
   i. Assume A is the MVP set which contains all available MVP candidates regardless of category, in one example, a first threshold is used for a first subset of candidates in set A, and a second threshold is used for a second subset of candidates (e.g. the rest candidates excluding those in the first subset) in set A.
   ii. In one example, a first threshold is used for a single group denoted by A, and a second threshold is used for another group (single or joint)/multiple other groups/rest of candidates which are not with the same category as those in A
      1) In one example, a first threshold is used for the single group of adjacent candidates, and a second threshold is used for the rest candidates, including but not limited to non-adjacent MVP, HMVP, pairwise MVP and zero MVP.
   iii. The first threshold may be larger than or smaller than the second threshold.
f) Alternatively, furthermore, the threshold for an MVP category or group may be dependent on the decoded information, e.g., block dimension/coding methods (e.g., CIIP/MMVD) and/or the variance of motion information within the category or group.
   2. Multi-pass reordering can be performed to construct an MVP list.
a) In one example, the multi-pass may involve different reordering criteria.
b) In one example, multi-pass reordering can be performed to multiple single/joint groups, wherein at least two single/joint groups may have overlap MVP candidates or not.
c) In one example, K-pass (e.g., K=2) reordering is used to construct an MVP list.
   i. In one example, in the first pass, a single/joint group A is firstly reordered based on a first cost (e.g. template matching cost) sorting, and the candidate with the largest cost (CL) in A is identified and then transferred to another single/joint group B (e.g. B may comprise the rest of candidates which are not with the same category as those in A). Subsequently, group B conduct the 2 to K pass reorder based on the first cost (or other cost metrics) sorting. Finally, the candidates in group A (except CL) and B (CL included) are included in the MVP list in accordance with the sorted order.
   ii. In one example, the group A in above case is a single group of adjacent candidates, and group B is a joint group of non-adjacent candidates and HMVP.
   iii. Alternatively, group A and B may be any other single or joint candidate group.
   iv. In one example, in the first pass, one or multiple single/joint groups are firstly reordered based on a first cost (e.g. template matching cost) sorting. Then a preliminary MVP list is constructed by inserting some of the candidates in each group into the list with the sorted order. Subsequently, the preliminary MVP list performs the second pass reorder to select partial candidates into the ultimate MVP list.
      1) In one example, different single/joint groups may have overlap candidates or not.
      2) In one example, all of the candidates in the preliminary MVP list are selected from the sorted single/joint groups.
      3) Alternatively, partial candidates in the preliminary MVP list are selected from the sorted groups, and the rest candidates are included into the list with other rules.
      4) In one example, in the second pass, all the candidates in the preliminary list, regardless of the corresponding categories, are sorted based on a cost (e.g. template matching cost), and only limited number of candidates are included into the ultimate MVP list based on the sorted order.
         a) Alternatively, furthermore, all the candidates in the preliminary MVP list are included in the ultimate MVP list in accordance with the sorted order.
      5) The cost (e.g. template matching cost) calculated in a former pass can be re-used in a later pass.
         a) In one example, when the cost for a certain candidate is calculated in a former pass, it will be saved in a variable or any other data structure in case the same cost is needed in a later pass.
         b) In one example, in a later pass, if the cost for a certain candidate is needed, it will first check whether this cost has been calculated before or not. If this cost has been calculated and/or saved before, and/or is accessible in the current pass, it will be fetched in the current pass instead of calculating again.
            3. At least one virtual candidate (e.g., pairwise MVP and zero MVP) may be involved in the at least one group.
a) In one example, all the virtual candidates are treated with one joint group.
   i. Alternatively, each category of virtual candidates is treated as a single group.
   ii. In one example, the pairwise MVP and/or zero MVP are included in a single/joint group.
   iii. Alternatively, furthermore, the group which contains the virtual candidates is reordered and then put into a candidate list.
b) Alternatively, the virtual candidates (e.g., pairwise MVP and/or zero MVP) are not included in any single/joint group.
   i. Alternatively, furthermore, no reordering process is applied to virtual candidates.
      1) Alternatively, furthermore, they may be further appended to candidate list.
   ii. In one example, one or more single/joint groups are constructed, where partial or all of the groups are reordered. In this case, at least one position in MVP list is preserved for the virtual candidates (e.g., pairwise MVP and/or zero MVP), which are appended to MVP list as the last or any other entry.
   iii. In one example, furthermore, a single group of adjacent candidates is firstly included in the MVP list, then a joint group of non-adjacent and HMVP are reordered and subsequently appended to MVP list. In this case, at least one position is preserved for the virtual candidates (e.g., pairwise MVP and/or zero MVP), which are appended to MVP list as the last or any other entry.
   iv. In one example, furthermore, a joint group of adjacent candidates, non-adjacent and HMVP are reordered and subsequently appended to MVP list, and the virtual candidates (e.g., pairwise MVP and/or zero MVP) are appended to MVP list as the last or any other entry.
c) Alternatively, the virtual candidates (e.g., pairwise MVP) of one category is included in a single/joint group and the virtual candidates of another category is not included.
d) In one example, no virtual candidates (e.g., pairwise MVP and/or zero MVP) appear in the ultimate MVP list when reordering operation is performed for MVP list construction.
   4. The number of candidates of a single/joint group may not be allowed to exceed a maximum candidate number.
a) In one example, a single/joint group is constructed with limited amount of candidates constrained by maximum number Nᵢ, where i∈[0,1, . . . ,K] is the index of the corresponding group. Nᵢ may be the same or they may be different for different i.
b) In one example, partial candidates in a single/joint group are limited by maximum number Nᵢ.
   i. In one example, one or multiple categories of candidates in a group are constructed with limited amount Nᵢ, while other categories in the same group can be included with arbitrary number.
      1) In one example, the categories include but not limited to adjacent candidates, non-adjacent candidates, HMVP, pairwise candidates, etc.
c) Alternatively, a first single/joint group may be constructed with at most Nᵢ MVP candidates, while a second single/joint groups may not have such constraint.
d) In one example, Nᵢ is a fix value shared by both encoder and decoder.
   i. Alternatively, Nᵢ is determined by encoder and signalled in the bitstream. And decoder decodes Ni value and then construct the corresponding iₜₕ single/joint group with at most Nᵢ candidates.
   ii. Alternatively, Nᵢ is derived in both encoder and decoder with the same operations, such that there is no need to signal the Nᵢ value.
      1) In one example, encoder and decoder may derive the Nᵢ value based on the variance of all available motion information for iₜₕ group.
      2) Alternatively, encoder and decoder may derive the Nᵢ value based on the number of all available candidates for iₜₕ group.
      3) In one example, encoder and decoder may derive the Nᵢ value based on the number of the available adjacent candidates.
         a) In one example, Nᵢ is set to N-NADJ, where N is a constant, N_{ADJ} is the number of the available adjacent candidates.
      4) Alternatively, furthermore, encoder and decoder may derive the Nᵢ value based on any information that encoder/decoder can both access to when constructing the MVP list.
e) In one example, all or partial of the single/joint groups may share a same maximum candidate number N.
   5. The construction of a single/joint group may depend on the maximum number constraint Nᵢ.
a) In one example, all available MVP candidates for iₜₕ group are included in the group in accordance with a certain order. Once the candidate number in the current group reaches Nᵢ, the construction for group i is terminated.
b) In one example, in above case, the order for group construction may be derived based on the distance between to-be-coded CU and MVP candidates, where a closer MVP candidate is assigned with a higher priority.
c) Alternatively, the order may be derived based on a cost (such as a template matching) cost, where an MVP with a less cost has a higher priority.
d) In one example, the construction of single/joint group is performed with at least one pruning operation in at least one group, or between groups.
e) In one example, the constructed single/joint group is further reordered based on at least one cost method (e.g., template matching cost), then some or all of the candidates in this group may be included in the MVP list.
   i. Alternatively, the candidates in the constructed single/joint group will not be further reordered, and some or all of the candidates in this group are included into the MVP list in the same order as they are included in the group.
      6. On how to prune MVP candidates.
a) In one example, K-pass (e.g., K=2) pruning is performed to build an MVP list.
   1) In one example, a first pruning may be performed inside at least one single/joint group, and a second pass pruning may be performed between at least two candidates that belong to different groups.
      a) In one example, in the first pass pruning, the pruning thresholds for two single/joint groups may be the same, or may be different.
      b) In one example, furthermore, in the first pass pruning, some of single/joint groups may share a same threshold value, while other single/joint groups may use different threshold values.
   2) In one example, furthermore, the threshold for a certain pass or group is determined by the decoding information, including but not limited to the block size, coding tools been used (e.g., TM, DMVR, adaptive DMVR, CIIP, AFFINE, AMVP-merge).
      a) Alternatively, a threshold may be determined by at least one syntax element signaled to the decoder.
         7. It is proposed to introduce K (e.g., K=2) co-located frames in video coding process.
a) In one example, motion vectors stored in at least one of the K co-located frames may be used to encode/decode the current frame.
b) In one example, these co-located frames can be arbitrary reconstructed frames in decoding picture buffer (DPB).
c) In one example, these co-located frames can be arbitrary reconstructed frames in arbitrary reference list.
   i. In one example, if the current to-be-coded frame has one or more than one reference lists, then the co-located frames may be selected from one or more than one list.
      1) In one example, if the reference frames with index N (e.g., N=0) in each list are not the same one (e.g. with different POC value), then these reference frames are selected as co-located frames.
         a) In another example, the reference frames with top-N index in each list are selected as co-located frames after performing redundance checking.
         b) Alternatively, any reference frame in arbitrary lists can be selected as co-located frames.
      2) In one example, if the current to-be-coded frame has one or more than one reference lists, the selected co-located frames may come from only one reference list.
         a) In one example, if the contents in each reference list are the same (e.g. low delay case), the selected co-located frames may come from only one reference list.
            8. On how to select co-located frames. Let S denote the set that contains all the available reconstructed frames in DPB or reference list, and SK is an arbitrary candidate in S. Then:
a) Whether SK can be selected as co-located frame may be dependent on the POC distance between the to-be-coded frame and SK.
   i. In one example, all the candidates in S are sorted based on the POC distance between the to-be-coded frame and each candidate, then the top-N (N>0) candidates with the smallest distance are selected as co-located frames.
   ii. In one example, SK can be selected as a co-located frame only if the distance between it and the to-be-coded frame is smaller or larger than a threshold T (T>0).
b) Whether SK can be selected as co-located frame may be dependent on the quantization parameter (QP) value.
   i. In one example, all the candidates in S are sorted based on the QP value, then the top-N (N>0) candidates with the smallest or largest QP are selected as co-located frames.
   ii. In one example, all the candidates in S are sorted based on the absolute QP distance between the to-be-coded frame and each candidate, then the top-N (N>0) candidates with the smallest distance are selected as co-located frames.
   iii. In one example, SK can be selected as a co-located frame only if the absolute QP difference between it and the to-be-coded frame is smaller or larger than a threshold T (T>0).
c) In one example, multiple metrics are combined to determine which one is used as co-located frame.
   i. In one example, if N (N>1) frames in reference list or DPB have equal POC distance relative to the to-be-coded frame, then those with larger (or smaller) QP (or absolute QP distance relative to the to-be-coded frame) have higher priority to be selected as co-located frame.

2ii In one example, if N (N>1) frames in reference list or DPB have equal QP, then those with larger (or smaller) POC (or absolute QP distance relative to the to-be-coded frame) have higher priority to be selected as co-located frame.

2iii. In one example, alternatively, if N (N>1) frames in reference list or DPB have equal absolute QP distance relative to the to-be-coded frame, then those with smaller (or larger) QP (or POC distance relative to the to-be-coded frame) have higher priority to be selected as co-located frame.

9. The selected co-located frame(s) may be signalled in the bitstream, including but not limited to slice header or SPS or PPS or picture parameter header.
a) Alternatively, both encoder and decoder derive the co-located frames based on a predefined rule, such that no additional information is needed to be transmitted.
b) In one example, the number of co-located frame(s) (denoted as N) may be coded in the bitstream.
c) In one example, indications of N co-located frames may be signalled after the number N is signalled.
d) In one example, a co-located frames may be indicated by a reference list and/or a reference index.
e) In one example, signalling of a first co-located frame may depend on a second co-located frame signalled before.

f) More than one co-located frames may be jointly coded.

g) A syntax element used to signal co-located frame(s) may be binarized with a fixed length coded, unary code, truncated unary code, Exponential Golomb code or any other coding methods.

h) In one example, the information related to co-located frame(s) may be signalled only if TMVP is enabled.

10. It is proposed to introduce K (k>=1) TMVPs in video coding process, which may locate in one or multiple co-located frames.
a) In one example, at most C (C>=0) TMVPs are inserted into MVP/TMVP candidate list regardless whether they are from one or multiple co-located frames, where C is a constant or an adaptively determined number.
b) In one example, in the MVP/TMVP candidate list, the maximum allowed number of TMVP in a certain co-located frame is constrained by a constant or an adaptively determined number.
c) In one example, encoder traverses all the co-located frames in a predefined or adaptively determined order to get in total C (C>=0) TMVPs, and for each co-located frame, at most D (D>=0) TMVPs is obtained, where D may vary from one co-located frame to another. The traversing process terminates when the total number of TMVP reaches C, or all the co-located frames have been traversed.
d) In one example, the number of TMVPs to be used in a list may be signalled in the bitstream, such as in SPS/PPS/picture header/slice header/etc.
   11. Different co-located frames may be assigned with different priority.
a) In one example, the priority of a co-located frame is determined based on the corresponding QP value, where those with larger QP are assigned with higher priority.
   i. Alternatively, the co-located frames with smaller QP are assigned with higher priority.
b) In one example, the priority of a co-located frame is determined based on the temporal distance relative to the current frame, where those with smaller distance are assigned with higher priority.
   i. Alternatively, a co-located frame with a larger distance is assigned with a higher priority.
c) In one example, this priority is associated with TMVP construction process and any other process in video coding.
   i. In one example, all the co-located frames are traversed in a descending order of priority. When an arbitrary co-located frame Fi is selected, K (K>=0) positions will be traversed to include TMVPs in the TMVP/MVP candidate list, where K may be the same for each co-located frame, or be different from one to another. Once the number of existing TMVP reaches the maximum allowed number M (M>=0), the iteration terminates and the co-located frames with lower priority are skipped. Otherwise, all the co-located frames will be traversed to construct TMVP/MVP candidate list.
   ii. In another example, K (K>=0) positions are respectively checked in accordance with some certain orders to get TMVP candidates. For i-th position being checked, the specific position in all the co-located frames are traversed in a descending order of priority, and the available TMVPs are included in the list. Once the number of existing TMVP candidates reaches the maximum allowed number M (M>=0), the iteration terminates and the rest positions and co-located frames with lower priority are skipped. Otherwise, all the positions and co-located frames will be traversed to constructed TMVP/MVP candidate list.
      1) Alternatively, in above case, for a certain TMVP position, at most N (N>=0) TMVPs are included in the list.
         a) In one example, for a certain TMVP position, if N (N>=0) TMVPs in high-priority co-located frame has already been included in the list, the same position in low-priority co-located frames will not be checked.
         b) Alternatively, for a certain TMVP position, arbitrary N (N>=0) TMVPs can be included in the list regardless of priority.
d) In one example, a co-located frame with a lower priority is used as backup, which is activated only when TMVP or any other information in a high-priority co-located frame does not exist.
   i. In one example, for a certain position in different co-located frames, if the required information (e.g. TMVP) in high-priority co-located frame is available, then this information is used in coding process, and the checking process for the following co-located frames is skipped. Otherwise, the same position in low-priority co-located frames are checked, and the corresponding information is used if it exists.
   ii. Alternatively, in above case, the information in lower-priority co-located frames are also used even though that of high-priority co-located frames exists.
e) Alternatively, different co-located frames are assigned with equal priority.
   i. In one example, a TMVP candidate set is built to include all or part of the potential TMVPs that may locate in any one of the co-located frames, which is then sorted in a certain order (e.g. template matching cost), and top-N (N>=0) candidates in the sorted list will be selected as the ultimate TMVPs.
      12. The proposed co-located frames can be used in any coding tool in video coding process, including but not limited to regular/CIIP/MMVD/GPM/TPM/subblock merge, AMVP, AFFINE, adaptive DMVR and so on.
a) In one example, M (M>=0) TMVPs are selected from N (N>=0) co-located frames, where each co-located frame selects equal number of TMVPs or not.
b) In one example, TMVP candidate lists are firstly built, then all or partial of the candidates in the TMVP lists are included in the ultimate MVP list.
   i. In one example, S (S>=0) TMVP candidate lists are firstly built, which is then respectively sorted in some certain metrics, e.g. template matching cost, and top-M (M>=0) candidates in each TMVP list are included into the ultimate merge candidate list, where K may be a same constant for all the co-located frame, or be different from one to another.
   ii. In one example, the TMVP candidate list is respectively built for each one of the co-located frames, each list include all or partial of available TMVP candidates in the corresponding co-located frame, which is then sorted in a certain metrics, e.g. template matching cost, and top-M (M>=0) candidates are included into the ultimate merge candidate list, where K may be a same constant for all the co-located frame, or be different from one to another.
   iii. In one example, alternatively, only one TMVP candidate list is built to include all or a constant number of available TMVP candidates in all the co-located frame, which is then sorted in a certain metrics, e.g. template matching cost, and top-M (M>=0) candidates are included into the ultimate merge candidate list.
   iv. In one example, the sorting metric mentioned above can also be the distance between a certain candidate and the current block.
c) In one example, alternatively, no TMVP candidate lists needs to be built, the TMVPs associated with some certain positions in one or multiple co-located frames are directly included int the MVP list.
d) In one example, alternatively, H (H>=0) TMVP candidates are firstly included in a joint candidate group which contains multiple types of MVP candidates, then top-M (M>=0) candidates are included into the ultimate merge candidate list in accordance with some certain metrics.
   i. The type of the MVP candidates in the joint group includes but not limited to adjacent candidates, non-adjacent candidates, HMVPs, zero candidates, constructed candidates and so on.
   ii. H (H>=0) TMVP candidates may be collected from partial or all of the co-located frames.
   iii. In one example, the sorting metric can be templated matching cost or bilateral matching cost.
      13. In one example, at least two TMVPs which may come from different co-located frames may be jointly used to generate the final prediction.
a) In one example, the average or weighted average of the two or more TMVPs may be used as an MV or MVP of the current block.
b) In one example, the predictions generated by the two or more TMVPs may be averaged or weighted averaged to generate a prediction of the current block.
   14. It is proposed to construct at least one motion shift list to derive the motion shift for TMVP or SbTMVP.
a) In one example, each candidate in the motion shift list is an MV that point to the corresponding collocated frame.
b) In one example, the motion shift candidate in the list can be obtained from a certain block such as a CU that has already been coded.
   i. In one example, the motion information of a coded CU is firstly obtained, if the corresponding MV points to a certain collocated frame, then this MV is inserted into the motion shift list after performing redundancy checking.
   ii. In one example, specifically, a motion shift candidate can be an adjacent candidate, which is obtained from a neighbouring CU.
      1) In one example, only some fixed positions can be used to obtain adjacent candidates.
      2) Alternatively, arbitrary adjacent positions can be used to obtain adjacent candidates.
   iii. In one example, specifically, a motion shift candidate can be a non-adjacent candidate, which is obtained from a non-neighbouring CU.
      1) In one example, only some fixed positions can be used to obtain non-adjacent candidates.
      2) Alternatively, arbitrary non-adjacent positions can be used to obtain non-adjacent candidates.
   iv. In one example, specifically, a motion shift candidate can be obtained from an MV list that keeps the MV of CUs in the history.
      1) In one example, the motion shift candidate is obtained from history-based MVP (HMVP) list.
   v. In one example, specifically, a motion shift candidate may be a virtual candidate.
      1) In one example, a motion candidate may be a zero candidate or constructed candidate.
   vi. Alternatively, a motion shift candidate may be arbitrary MV that points to the collocated frame.
c) In one example, the MVP candidate list constructed for some certain coding modes, e.g. regular/CIIP/MMVD/GPM/TPM, can be re-used to obtain motion shift candidates.
   15. The motion shift lists may be constructed along with pruning process.
a) In one example, pruning process is used to avoid repeating or redundant motion shift with the list, which can be realized by using appropriate threshold TH.
b) In one example, if two motion shift candidates point to the same collocated frame, they may both be included to motion shift list only if the absolute difference between the corresponding X and Y components are either or both larger (or no smaller) than TH.
c) The pruning threshold can be signalled in the bitstream.
   i. In one example, the pruning threshold can be signalled either in PU, CU, CTU or slice level.
d) The pruning threshold may depend on the characteristics of the current block.
   i. In one example, the threshold may be derived by analysing the diversity among the candidates.
   ii. In one example, the optimal threshold can be derived through RDO.
      16. K (K>=1) motion shift lists may be constructed to derive at least one SbTMVP candidate.
a) In one example, the number of the candidates in each list may not exceed a certain constant.
b) In one example, only one motion shift list is constructed to derive SbTMVP candidates.
c) In one example, D (D>=0) motion shifts are selected from each list, where D may be a same value for arbitrary motion candidate list, or be different from one to another.
d) In one example, the number of motion shift list to be constructed may be dependent on the number of collocated frames.
   i. In one example, only one motion shift list is constructed for all the collocated frames.
      1) In one example, specifically, the motion information of a potential motion shift candidate is firstly obtained, if the corresponding MV in arbitrary reference picture list points to either of M (M>=1) collocated frames, then this MV is inserted into the motion shift list after performing redundancy checking.
   ii. In one example, the number of the list may be equal to the number of collocated frames, where one motion shift list is constructed for each of the collocated frames.
      1) In one example, for each of collocated frame, the corresponding motion shift list is constructed by including the motion candidates that have MV in either reference list that points to the current collocated frame. In particular, the motion information of a potential motion shift candidate is firstly obtained, if the corresponding MV points to the current collocated frame, then this MV is inserted into the motion shift list built for the current collocated frame after performing redundancy checking.
         17. The constructed motion shift lists may be sorted based on at least one certain metric.
a) In one example, the metrics may be template matching cost or bilateral matching cost.
b) In one example, the reference template locates in the collocated frame, and the current template locates in the to-be-coded frame, then the template matching cost is calculated for partial or all of the motion shift candidates.
c) In one example, the motion shift lists may be sorted based on the template matching of the motion shift candidates within the lists.
d) In one example, Q (Q>=1) reordering process may be conducted to motion shift list.
   i. The Q reordering process may be conducted in a cascade way or in a parallel way.
   ii. In one example, for certain types of candidates, a candidate group is firstly constructed, then first K (0<K<Q) pass reordering is performed to select partial candidates in the motion shift list. The last pass reordering is performed to reorder all the candidates in the motion shift list.
      18. H (H>=1) SbTMVP candidates may be included in the sub-CU level MVP candidate list.
a) In one example, partial or all of the candidates in the motion shift lists are used to derive SbTMVP candidates.
b) In one example, at most Q (Q>0) motion shifts are used to derive SbTMVP candidates in one motion shift list.
c) In one example, no motion shift is used to derive SbTMVP candidates in certain motion shift list.
   19. Top-M (M>0) candidates with the least metric cost in each motion shift list may be used to derive SbTMVP candidates.
a) In one example, M may be a same value for each list, or be different from one to another.
b) In one example, the cost of the motion shift candidates which belong to different motion shift lists may be compared to determine which one(s) could be used to derive SbTMVP candidates.
   i. In one example, the cost of it motion shift candidate in list A may be compared with that of the j-th candidate in list B, and the one with smaller cost will be used to derive SbTMVP candidate.
      20. Before the motion shift is used to derived SbTMVP candidates, it may be firstly refined through template matching process or not.
      21. A new motion shift may be constructed by the existing ones in the list.
a) In one example, a motion shift may be constructed by the averaging the arbitrary K (K>1) shifts in the list.
b) In one example, the constructed motion shift is reordered together with the ones in the motion candidate list.
   i. In one example, the constructed motion shift may be used to derive SbTMVP candidate if it satisfys certain conditions as other normal shift candidates.
      22. On reordering of SbTMVP candidates. Once the SbTMVPs are derived based on the motion shifts selected from one or multiple motion shift list(s), they will be included in the sub-CU level MVP candidate list and then may be reordered according to certain metrics.
a) In one example, the metrics may be template matching cost or bilateral matching cost.
b) In one example, the metrics (e.g. template matching cost) for partial or all of the SbTMVPs and AFFINE candidates in the list are calculated, then partial or all of the candidates are reordered in a descending (or ascending) order of the metrics.
   i. In one example, all the SbTMVP candidates are reordered based on certain metrics, then the all the sorted SbTMVP candidates may be placed in front (or behind) of all or partial of the AFFINE candidates.
   ii. In one example, partial SbTMVP candidates are reordered together with all the AFFINE candidates, where other SbTMVP candidates will always be placed in a fix position in the list.
      1) In one example, specifically, which SbTMVP candidates are reordered or not may depends on the collocated frames.
         a) In one example, which SbTMVP candidate(s) are reordered or not may depends on the priority of the collocated frame it (they) locate(s). i. In one example, the collocated frames that are closer to the to-be-coded frame are assigned with higher priority. ii. In one example, all or partial of the SbTMVP candidates that locate in the collocated frame with top-W (W>0) highest priority will not be reordered. 1. In one example, these SbTMVP candidates may always be placed in the most front positions in the list. 2. In one example, alternatively, these SbTMVP candidates may be placed in arbitrary fixed positions in the list. 3. Alternatively, these SbTMVP candidates may be placed in arbitrary arbitrary positions in the list.
      2) In one example, specifically, which SbTMVP candidates are reordered or not may depends on the rank of the corresponding motion shift in the motion shift list.
         a) In one example, the SbTMVP candidates of which the motion shifts have higher (or lower) rank may not be reordered but placed in the most front positions in the list.
      3) In one example, specifically, which SbTMVP candidates are reordered or not may depends on both of the corresponding rank of the motion shift in the motion shift list, and the collocated frame they locate.
         a) In one example, if the SbTMVP locates in the top-M (M>0) highest-priority frame, and the associated motion shift ranks top-N (N>0) in the corresponding motion shift list, this SbTMVP may be placed in the first (or any other) position in the sorted sub-CU level MVP candidate list.
            23. In one example, a motion shift fetched from a motion shift list may be refined before it is used to locate a position in at least one collocated frame for TMVP or sbTMVP.
a) In one example, the motion shift may be refined by templated matching.
b) In one example, the motion shift may be refined by biliteral matching.
c) In one example, the motion shift may be refined by adding a delta MV.
d) In one example, the motion shift may be refined by clipping.
e) In one example, the motion shift may be refined by shifting.
   24. In one example, multiple motion shifts (denoted as SM0, SM1, . . . . SMn) which may be from a motion shift list may be jointly used to derive a final motion shift (denoted as SMf) to locate a position in at least one collocated frame for TMVP or sbTMVP. E.g. SMf=F (SM0, SM1, . . . , SMn).
a) In one example, SMf=(SM0+SMI + . . . +SMn)/n.
b) In one example, SMf=max (SM0, SM1, . . . , SMn).
c) In one example, SMf=min (SM0, SM1, . . . , SMn).
d) In one example, SMf=middle (SM0, SM1, . . . , SMn).
e) In one example, SMf=(W1*SM0 +W* SM1+ . . . +W3*SMn)/(W1+W2+ . . . +Wn).

### 5. Embodiments

In one example, when encoder/decoder starts to build an MVP candidate list for merge mode, different methods are used for different merge modes. In particular, if the current mode is regular/CIIP/MMVD/GPM/TPM/subblock merge mode, adjacent candidates are firstly put into MVP candidate list with a smaller pruning threshold T₁. Then a joint group which contains one or more than one category of MVP candidates (e.g. non-adjacent and HMVP candidates, note that a joint group can also comprises different partial or combination of candidates) is built, and pruning operation with a larger threshold T₂ is conducted within the joint group. In particular, at most M (e.g. 20) candidates are included in the joint group, where closer MVP positions have higher priority to be included. If the candidate number in the joint group reaches M, the construction for the joint group is terminated. Subsequently, template matching cost associated with each candidate within the join group is calculated. After that, encoder/decoder will append MVP list by traversing the candidates in the joint group in an ascending order of template matching cost until all the candidates in the joint group are traversed, or MVP list reaches Nₘₐₓ₋₁, where Nₘₐₓ₋₁=Nₘₐₓ−1, and Nₘₐₓ is the maximum allowed candidate number in MVP list. If all the candidates within the joint group are traversed and MVP list still has vacant positions, remaining candidates which are not belong to the joint group will be included in the MVP list in a predefined order until the list reaches Nₘₐₓ₋₁.Finally, pairwise MVP and/or zero MVP are appended to MVP list.

If current merge mode is template matching merge mode, a joint group which contains different category of MVP candidates (e.g. adjacent, non-adjacent and HMVP candidates, note that a joint group can also comprises different partial or combination of candidates) is firstly built, then pruning process and template Matching cost derivation are conducted in the same way as regular/CIIP/MMVD/GPM/TPM/subblock merge mode, where a smaller threshold is used for adjacent candidates, and a larger threshold is used for other candidates. In particular, at most K (e.g. 20) candidates are included in the joint group, where closer MVP positions have higher priority to be included. If the candidate number in the joint group reaches K, the construction for the joint group is terminated. Then, encoder/decoder will construct MVP list by traversing the candidates in the joint group in an ascending order of template matching cost until all the candidates in the joint group are traversed, or MVP list reaches Nₘₐₓ₋₁.If all the candidates within the joint group are traversed and MVP list still has vacant positions, remaining candidates which are not belong to the joint group will be included in the MVP list in a predefined order until the list reaches Nₘₐₓ₋₁. Finally, pairwise MVP and/or zero MVP are appended to MVP list.

In another example, when encoder/decoder starts to build an MVP candidate list for merge mode, different methods are used for different merge modes. In particular, if the current mode is regular/CIIP/MMVD/GPM/TPM/subblock merge mode, a single group of adjacent MVP is constructed with a smaller pruning threshold T1, and the template matching cost associated with each candidates within the single group is calculated. After that, all the candidates in the single group are put into the MVP list except the one (termed as C_{Largest}) with the largest template matching cost. Then a joint group which contains one or more than one category of MVP candidates (e.g. non-adjacent and HMVP candidates, note that a joint group can also comprises different partial or combination of candidates) is built, and pruning operation with a larger threshold T2 is conducted within the joint group. In particular, C_{Largest} is firstly included in the joint group as the first entry. And at most M (e.g. 20) candidates are included in the joint group, where closer MVP positions have higher priority to be included. If the candidate number in the joint group reaches M, the construction for the joint group is terminated. Subsequently, template matching cost associated with each candidate within the join group is calculated. After that, encoder/decoder will append MVP list by traversing the candidates in the joint group in an ascending order of template matching cost until all the candidates in the joint group are traversed, or MVP list reaches Nₘₐₓ₋₁.If all the candidates within the joint group are traversed and MVP list still has vacant positions, remaining candidates which are not belong to the joint group will be included in the MVP list in a predefined order until the list reaches Nₘₐₓ₋₁.Finally, pairwise MVP and/or zero MVP are appended to MVP list. In one example, K (e.g. K=2) co-located frames are derived before the to-be-coded frame initiates coding process, which is realized by selecting the top-M (e.g. M=1) frames with the least reference index in each reference frame list. It should be noted that the selected co-located frames are assigned with different priority in terms of the TMVP derivation, where those with larger QP (or closer POC distance/absolute QP distance relative to the current frame) are assigned with higher priority.

Then, for regular/CIIP/MMVD/GPM/TPM/subblock merge mode, AMVP/AFFINE mode/adaptive DMVR mode or any other coding mode that requires MVP list construction, these K co-located frames can be utilized to provide N (N>=0) TMVPs. In particular, for certain coding modes (e.g. regular/CIIP/MMVD/GPM/TPM/subblock merge mode and AMVP), each co-located frame will build a TMVP candidate list that contains all or partial of TMVP candidates within it, yielding in total K TMVP candidate lists. These TMVP list are then respectively reordered based on template or bilateral matching cost. Afterwards, S (S>0) rounds of iteration are performed to include at most N (N>=0) TMVPs in the ultimate MVP candidate list. Specifically, during the i-th (i<S) iteration, the i-th candidate in each sorted TMVP list is traversed in a descending order of the priority associated with the corresponding co-located frame, and will be included in the ultimate MVP list after performing redundance checking.

In another example, K (e.g. K=2) co-located frames are derived before the to-be-coded frame initiates coding process, which is realized by selecting the top-M (e.g. M=1) frames with the least reference index in each reference frame list. It should be noted that the selected co-located frames are assigned with equal priority in terms of the TMVP derivation.

Then, for regular/CIIP/MMVD/GPM/TPM/subblock merge mode, AMVP/AFFINE mode/adaptive DMVR mode or any other coding mode that requires MVP list construction, these K co-located frames can be utilized to provide N (N>=0) TMVPs. In particular, for certain coding modes (e.g. regular/CIIP/MMVD/GPM/TPM/subblock merge mode and AMVP), only one TMVP candidate lists is built for all the co-located frame along with redundance checking process. The constructed list contains all or partial of the TMVP candidates that may locate in any one of the co-located frames, which is then reordered based on template or bilateral matching cost. Afterwards, the first N candidates with the least cost are included in the ultimate MVP list.

In one example, when constructing sub-CU level MVP candidate list, if M (e.g. M=2) collocated frames are utilized in the coding process, then M (e.g. M=2) motion shift candidate lists are respectively constructed for each of the collocated frame. In particular, when constructing the motion shift list Li for i-th collocated frame Cᵢ, adjacent motion candidates, non-adjacent motion candidates, HMVP candidates and virtual motion candidates are collected in order. Specifically, a non-adjacent candidates group is firstly constructed which contains at most F(F>0) candidates. This candidate group is then reordered based on template matching cost, and at most S(0<S<F) candidates with the least cost are selected in the motion shift list. For a certain candidates, if the MV in arbitrary reference list points to Cᵢ, this MV will be included in Li after pruning process. The constructed motion shift lists for each collocated frame is respectively reordered based on template matching cost, and the top-T candidates with the least cost are used to derive SbTMVP candidates, which are then included in the sub-CU level MVP candidate list. Once all the SbTMVP candidates are included in the list, reordering process initiates. In particular, the SbTMVP candidates that are derived based on the motion shift from the highest-priority collocated frame are identified, and the one of which the motion shift ranks 1-st in the corresponding shift list is not reordered, which will placed in the 1-st place in the ultimate MVP list, and all the other SbTMVP candidates are sorted together with AFFINE candidates.

FIG. 12 illustrates a flowchart of a method 1200 for video processing in accordance with embodiments of the present disclosure. The method 1200 may be implemented for a conversion between a current video block of a video and a bitstream of the video.

At block 1210, a plurality of co-located frames of the current video block is determined. The current video block is in a current frame co-located with the plurality of co-located frame.

At block 1220, the conversion is performed based on the plurality of co-located frames. In some embodiments, the conversion may include encoding the current video block into the bitstream. Alternatively, or in addition, in some embodiments, the conversion may include decoding the current video block from the bitstream.

The method 1200 enables perform the video processing such as the conversion between the current video block and the bitstream based on the plurality of co-located frames. In this way, temporal motion information of the plurality of co-located frames can be taken into consideration for the conversion. Coding effectiveness and coding efficiency can thus be improved.

In some embodiments, at least one motion vector (MV) associated with at least one of the plurality of co-located frames may be determined. At block 1220, the conversion may be performed based on the at least one MV.

In some embodiments, the plurality of co-located frames comprises reconstructed frames in a decoding picture buffer (DPB). For example, the co-located frames may be arbitrary reconstructed frames in DPB.

Alternatively, or in addition, in some embodiments, the plurality of co-located frames comprises reconstructed frames in a reference list. In some embodiments, the plurality of co-located frames is selected from at least one reference list associated with the current frame.

In some embodiments, the plurality of co-located frames comprises a first reference frame with a first index in a first reference list and a second reference frame with the first index in a second reference list, the first and second reference frames are different.

In some embodiments, a first picture order count (POC) value of the first reference frame is different from a second POC value of the second reference frame. For example, if the reference frames with index N (e.g., N may be zero) in each list are not the same one (for example, with different POC values), then these reference frames are selected as co-located frames.

In some embodiments, determining the plurality of co-located frames comprises: for a reference list in a plurality of candidate reference lists, selecting at least one candidate reference frame from the reference list based on indexes of reference frames in the reference list; and adding the at least one candidate reference frame into the plurality of co-located frames based on a comparison between the at least one candidate reference frame and a further co-located frames in the plurality of co-located frames.

In some embodiments, determining the plurality of co-located frames comprises: adding a reference frame in a reference list into the plurality of co-located frames.

In some embodiments, determining the plurality of co-located frames comprises: selecting a reference list from at least one reference list of the current frame; and adding a reference frame in the selected reference list into the plurality of co-located frames.

In some embodiments, contents in a first reference list of the current frame are same with contents in a second reference list of the current frame, and the plurality of co-located frames is selected from one of the first or second reference list. For example, for low delay case, if the contents such as frames un each reference list are the same, the selected co-located frames may come from only one reference list.

In some embodiments, determining the plurality of co-located frames comprises: determining a set of candidate frames in a decoding picture buffer (DPB) or a reference list; and selecting the plurality of co-located frames from the set of candidate frames.

In some embodiments, selecting the plurality of co-located frames from the set of candidate frames comprises: adding a candidate frame from the set of candidate frames into the plurality of co-located frames based on a metric, the metric being associated with at least one of the following: a picture order count (POC) distance between the candidate frame and the current frame, or a quantization parameter (QP) value of the candidate frame.

In some embodiments, if the POC distance between the candidate frame and the current frame is smaller than a threshold distance, the candidate frame is added into the plurality of co-located frames.

In some embodiments, if the POC distance between the candidate frame and the current frame is larger than a threshold distance, the candidate frame is added into the plurality of co-located frames.

In some embodiments, selecting the plurality of co-located frames from the set of candidate frames comprises: sorting the set of candidate frames based on POC distances between the set of candidate frames and the current frame in an ascending order; and selecting the plurality of co-located frames based on the sorting.

In some embodiments, if an absolute QP distance between the candidate frame and the current frame is smaller than a threshold distance, the candidate frame is added into the plurality of co-located frames.

In some embodiments, if an absolute QP distance between the candidate frame and the current frame is larger than a threshold distance, the candidate frame is added into the plurality of co-located frames.

In some embodiments, selecting the plurality of co-located frames from the set of candidate frames comprises: sorting the set of candidate frames based on absolute QP distances between the set of candidate frames and the current frame in a descending order or an ascending order; and selecting the plurality of co-located frames based on the sorting.

In some embodiments, selecting the plurality of co-located frames from the set of candidate frames comprises: sorting the set of candidate frames based on QP values of the set of candidate frames in an ascending order; and selecting the plurality of co-located frames based on the sorting.

In some embodiments, a first POC distance between a first candidate frame in the set of candidate frames and the current frame is equal to a second POC distance between a second candidate frame in the set of candidate frames and the current frame, and wherein the first candidate frame is added into the plurality of co-located frames if at least one of the following conditions is met: a first QP value of the first candidate frame is larger than a second QP value of the second candidate frame, or a first absolute QP distance between the first candidate frame and the current frame is larger than a second absolute QP distance between the second candidate frame and the current frame.

In some embodiments, a first POC distance between a first candidate frame in the set of candidate frames and the current frame is equal to a second POC distance between a second candidate frame in the set of candidate frames and the current frame, and wherein the first candidate frame is added into the plurality of co-located frames if at least one of the following conditions is met: a first QP value of the first candidate frame is smaller than a second QP value of the second candidate frame, or a first absolute QP distance between the first candidate frame and the current frame is smaller than a second absolute QP distance between the second candidate frame and the current frame.

In some embodiments, a first QP value of a first candidate frame in the set of candidate frames is equal to a second QP value of a second candidate frame in the set of candidate frames, and wherein the first candidate frame is added into the plurality of co-located frames if at least one of the following conditions is met: a first POC distance between the first candidate frame and the current frame is larger than a second POC distance between the second candidate frame and the current frame, or a first absolute QP distance between the first candidate frame and the current frame is larger than a second absolute QP distance between the second candidate frame and the current frame.

In some embodiments, a first QP value of a first candidate frame in the set of candidate frames is equal to a second QP value of a second candidate frame in the set of candidate frames, and wherein the first candidate frame is added into the plurality of co-located frames if at least one of the following conditions is met: a first POC distance between the first candidate frame and the current frame is smaller than a second POC distance between the second candidate frame and the current frame, or a first absolute QP distance between the first candidate frame and the current frame is smaller than a second absolute QP distance between the second candidate frame and the current frame.

In some embodiments, the first candidate frame is added into the plurality of co-located frames if at least one of the following conditions is met: a first POC distance between the first candidate frame and the current frame is larger than a second POC distance between the second candidate frame and the current frame, or a first QP value of the first candidate frame is larger than a second QP value of the second candidate frame.

In some embodiments, the first candidate frame is added into the plurality of co-located frames if at least one of the following conditions is met: a first POC distance between the first candidate frame and the current frame is smaller than a second POC distance between the second candidate frame and the current frame, or a first QP value of the first candidate frame is smaller than a second QP value of the second candidate frame.

In some embodiments, information of the plurality of co-located frames is included in the bitstream. In some embodiments, the information of the plurality of co-located frames is included in at least one of: a slice header, a sequence parameter set (SPS), a Picture Parameter Set (PPS), or a picture parameter header. That is, the selected co-located frame(s) may be signalled in the bitstream, including but not limited to slice header or SPS or PPS or picture parameter header.

In some embodiments, the information of the plurality of co-located frames comprises: the number of co-located frames in the plurality of co-located frames.

In some embodiments, a plurality of indications of the plurality of co-located frames is included in the bitstream, the plurality of indications being subsequent to the number of co-located frames. For example, indications of the plurality of co-located frames may be signalled after the number of the co-located frames is signalled.

In some embodiments, first information of a first co-located frame in the plurality of co-located frames is based on second information of a second co-located frame in the plurality of co-located frames, the first information being coded subsequent to the second information. That is, signaling of a first co-located frame may depend on a second co-located frame signaled before.

In some embodiments, the information of the plurality of co-located frames is jointly coded. That is, more than one co-located frames may be jointly coded.

In some embodiments, a syntax element including information of at least one co-located frames in the plurality of co-located frames is binarized with at least one of the following: a fixed length coding tool, a unary coding tool, a truncated unary coding tool, or an Exponential Golomb coding tool.

In some embodiments, if temporal motion vector prediction (TMVP) is enabled for the current frame, the information of the plurality of co-located frames is included in the bitstream.

In some embodiments, a co-located frame in the plurality of co-located frames is indicated by at least one of: a reference list, or a reference index.

In some embodiments, the method 1200 further comprises: determining the plurality of co-located frames based on a predefined rule by an encoder and a decoder associated with the conversion. In this way, no additional information is needed to be transmitted.

In some embodiments, priorities of the plurality of co-located frames are different.

In some embodiments, the method 1200 further comprises: determining a priority of a co-located frame of the plurality of co-located frames based on at least one of: a quantization parameter (QP) value of the co-located frame, or a temporal distance of the co-located frame relative to the current frame.

In some embodiments, if a first quantization parameter (QP) value of a first co-located frame is larger than a second QP value of a second co-located frame, a first priority of the first co-located frame is higher than a second priority of the second co-located frame.

In some embodiments, if a first quantization parameter (QP) value of a first co-located frame is smaller than a second QP value of a second co-located frame, a first priority of the first co-located frame is higher than a second priority of the second co-located frame.

In some embodiments, if a first temporal distance between a first co-located frame and the current frame is smaller than a second temporal distance between a second co-located frame and the current frame, a first priority of the first co-located frame is higher than a second priority of the second co-located frame.

In some embodiments, if a first temporal distance between a first co-located frame and the current frame is larger than a second temporal distance between a second co-located frame and the current frame, a first priority of the first co-located frame is higher than a second priority of the second co-located frame.

In some embodiments, priorities of the plurality of co-located frames are associated with a video coding process. In some embodiments, the video coding process comprises a temporal motion vector prediction (TMVP) constructure process.

In some embodiments, the method 1200 further comprises: determining a motion vector prediction (MVP) candidate list by traversing temporal MVPs (TMVPs) in the plurality of co-located frames based on a descending order of priorities of the plurality of co-located frames.

In some embodiments, the MVP candidate list comprises a TMVP candidate list.

In some embodiments, if the number of TMVPs in the MVP candidate list is larger than or equal to a threshold number, the traversing of the plurality of co-located frames is terminated.

In some embodiments, determining the MVP candidate list comprises: for a co-located frame in the plurality of co-located frames, including a set of TMVP by checking a set of positions of the co-located frame in the MVP candidate list, the number of positions in the set of positions being larger than or equal to zero.

In some embodiments, the first position number of positions associated with a first co-located frame is different from the second number of positions associated with a second co-located frame.

In some embodiments, the first number of positions associated with a first co-located frame is same with the second number of positions associated with a second co-located frame.

In some embodiments, the method 1200 further comprises: determining a motion vector prediction (MVP) candidate list by traversing temporal MVPs (TMVPs) in a set of positions in the plurality of co-located frames based on an order of the set of positions, the number of positions in the set of positions being greater than or equal to zero.

In some embodiments, traversing TMVPs comprises: for a position in the set of positions, traversing TMVPs in the position in the plurality of co-located frames based on a descending order of priorities of the plurality of co-located frames.

In some embodiments, for the position in the set of positions, the number of TMVPs to be added in the MVP candidate list is less than or equal to a second threshold number.

In some embodiments, if the number of TMVPs corresponding to the position in the MVP candidate list is larger than or equal to the second threshold number, the traversing of the TMVPs in the position in the plurality of co-located frames is terminated.

In some embodiments, for the position in the set of positions, the number of TMVPs to be added in the MVP candidate list is larger than or equal to zero.

In some embodiments, if the number of TMVPs in the MVP candidate list is larger than or equal to a third threshold number, the traversing of the TMVPS in the set of positions in the plurality of co-located frames is terminated.

In some embodiments, a co-located frame with a priority lower than a priority threshold in the plurality of co-located frames is a backup co-located frame.

In some embodiments, if temporal motion vector prediction or information in a further co-located frame with a priority higher than the priority threshold does not exist, the backup co-located frame is activated.

In some embodiments, first information for a position in a first co-located frame in the plurality of co-located frames is available, and the first information is used in the conversion.

In some embodiments, second information for the position in a second co-located frame in the plurality of co-located frames is not used, a priority of the second co-located frame is lower than a priority of the first co-located frame.

In some embodiments, the first information is not available, and the second information is used in the conversion.

In some embodiments, second information for the position in a second co-located frame in the plurality of co-located frames is used in the conversion, a priority of the second co-located frame is lower than a priority of the first co-located frame.

In some embodiments, the first or second information comprises a temporal motion vector prediction (TMVP).

In some embodiments, priorities of the plurality of co-located frames are the same.

In some embodiments, the method 1200 further comprises: determining a set of candidate temporal motion vector predictions (TMVPs) located in the plurality of co-located frames; sorting the set of candidate TMVPs in a predetermined order; and determining at least one TMVPs from the set of candidate TMVPs based on the sorting. In some embodiments, the predetermined order is based on a template matching cost.

In some embodiments, the method 1200 further comprises: determining at least one temporal motion vector prediction (TMVP) in at least one of the plurality of co-located frames.

In some embodiments, the method 1200 further comprises: adding the at least one TMVP into a candidate list, the number of the at least one TMVP being less than or equal to a first threshold number.

In some embodiments, the number of TMVP associated with a co-located frame of the plurality of co-located frames in the candidate list is less than or equal to a second threshold number.

In some embodiments, at least one of the first threshold number or the second threshold number is predefined or determined during the conversion.

In some embodiments, the candidate list comprises one of: a motion vector prediction (MVP) candidate list or a TMVP candidate list.

In some embodiments, determining the candidate list comprises: determining the at least one TMVP by traversing the plurality of co-located frames based on an order, the order being predefined or determined during the conversion.

In some embodiments, for a first co-located frame in the plurality of co-located frames, the number of TMVPs to be added into the at least one TMVP is less than or equal to a third threshold number.

In some embodiments, for a second co-located frame in the plurality of co-located frames, the number of TMVPs to be added into the at least one TMVP is less than or equal to a fourth threshold number, the fourth threshold number being different from the third threshold number.

In some embodiments, the traversing the plurality of co-located frames is terminated if the number of TMVPs added into the candidate list is larger than or equal to the first threshold number.

In some embodiments, the first threshold number is included in the bitstream.

In some embodiments, the first threshold number is included in at least one of the following: a sequence parameter set (SPS), a picture parameter set (PPS), a picture header, or a slice header.

In some embodiments, the plurality of co-located frames is used by a coding tool during the conversion, the coding tool comprising at least one of: a regular coding tool, a combined inter and intra prediction (CIIP) coding tool, a merge with motion vector difference (MMVD) coding tool, a geometric partitioning mode (GPM) coding tool, a triangle partition mode (TPM) coding tool, a subblock merge coding tool, an advanced motion vector prediction (AMVP) coding tool, an affine coding tool, or an adaptive decoder side motion vector refinement (DMVR) coding tool.

In some embodiments, the method 1200 further comprises: selecting a first set of temporal motion vector predictions (TMVPs) from a set of co-located frames in the plurality of co-located frames.

In some embodiments, a first number of TMVPs from a first co-located frame in the set of co-located frames is added into the first set of TMVPs, and a second number of TMVPs from a second co-located frame in the set of co-located frames is added into the first set of TMVPs, the first number being equal to or different from the second number.

In some embodiments, the method 1200 further comprises: determining at least one temporal motion vector prediction (TMVP) candidate list; and determining a motion vector prediction (MVP) list based on at least a partial of the at least one TMVP candidate list.

In some embodiments, determining the at least one TMVP candidate list comprises: determining a plurality of TMVP candidate list corresponding to the plurality of co-located frames, a TMVP candidate list in the plurality of TMVP candidate list comprising at least a partial of TMVP candidates in a respective co-located frame.

In some embodiments, determining the at least one TMVP candidate list comprises: determining a TMVP candidate list by adding at least a partial of TMVP candidates in the plurality of co-located frames.

In some embodiments, determining the MVP list comprises: sorting the at least one TMVP candidate list based on a metric; and determining the MVP list based on the sorting.

In some embodiments, the metric comprises at least one of the following: a template matching cost, or a distance between a TMVP candidate and the current video block.

In some embodiments, determining the MVP list based on the sorting comprises: adding a first number of TMVPs in a first TMVP candidate list of the at least one TMVP candidate list into the MVP list; and adding a second number of TMVPs in a second TMVP candidate list of the at least one TMVP candidate list into the MVP list.

In some embodiments, the first TMVP candidate list is associated with a first co-located frame in the plurality of co-located frames, and the second TMVP candidate list is associated with a second co-located frame in the plurality of co-located frames.

In some embodiments, the first and second numbers are different or the same.

In some embodiments, the method 1200 further comprises: determining a motion vector prediction (MVP) list by adding a plurality of temporal MVPs (TMVPs) associated with at least one position in the plurality of co-located frames into the MVP list.

In some embodiments, the method 1200 further comprises: determining a set of temporal motion vector predictions (TMVPs) based on at least a partial of the plurality of co-located frames; adding the set of TMVPs in a joint candidate group, the joint candidate group further comprising a candidate of a further candidate type; and determining a merge candidate list from the joint candidate group based on a metric.

In some embodiments, the further candidate type comprises at least one of the following: a type of adjacent candidate, a type of non-adjacent candidate, a type of history-based motion vector predictor (HMVP) candidate, a type of zero candidate, or a type of constructed candidate.

In some embodiments, the metric comprises at least one of: a template matching cost, or a bilateral matching cost.

In some embodiments, the method 1200 further comprises: determining a first temporal motion vector prediction (TMVP) from a first co-located frame of the plurality of co-located frames; determining a second TMVP from a second co-located frame of the plurality of co-located frames; and determining a prediction of the current video block based on the first and second TMVPs.

In some embodiments, determining the prediction comprises: determining the prediction based on an average or a weighted average of the first and second TMVPs.

In some embodiments, the method 1200 further comprises: determining a motion vector (MV) or a motion vector prediction (MVP) of the current video block based on an average or a weighted average of the first and second TMVPs.

According to further embodiments of the present disclosure, a non-transitory computer-readable recording medium is provided. The non-transitory computer-readable recording medium stores a bitstream of a video which is generated by a method performed by an apparatus for video processing. In the method, a plurality of co-located frames of a current video block of the video is determined. The current video block is in a current frame co-located with the plurality of co-located frames. The bitstream is generated based on the plurality of co-located frames.

According to still further embodiments of the present disclosure, a method for storing bitstream of a video is provided. In the method, a plurality of co-located frames of a current video block of the video is determined. The current video block is in a current frame co-located with the plurality of co-located frames. The bitstream is generated based on the plurality of co-located frames. The bitstream is stored in a non-transitory computer-readable recording medium.

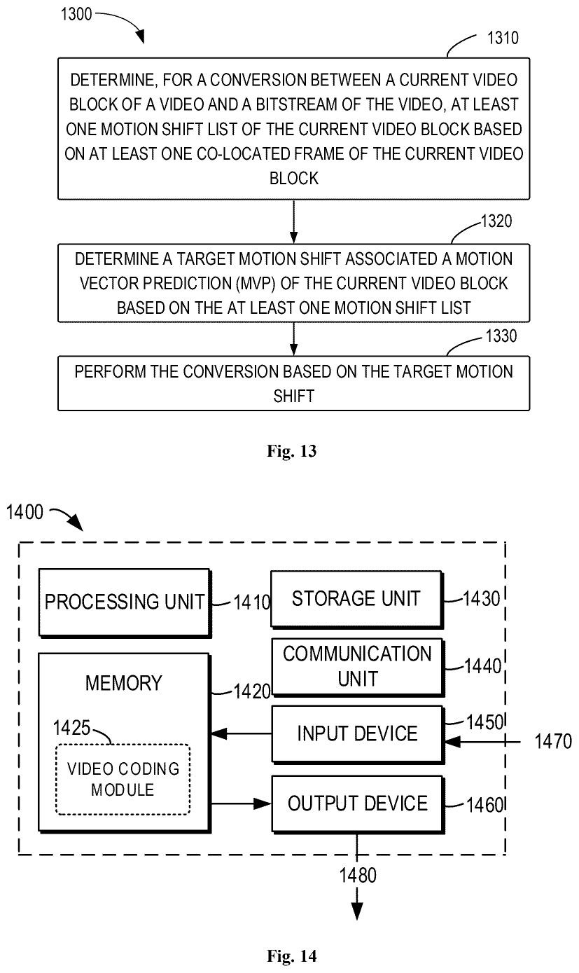

FIG. 13 illustrates a flowchart of a method 1300 for video processing in accordance with embodiments of the present disclosure. The method 1300 may be implemented for a conversion between a current video block of a video and a bitstream of the video.

At block 1310, at least one motion shift list of the current video block is determined based on at least one co-located frame of the current video block.

At block 1320, a target motion shift associated a motion vector prediction (MVP) of the current video block is determined based on the at least one motion shift list.

At block 1330, the conversion is performed based on the target motion shift. In some embodiments, the conversion may include encoding the current video block into the bitstream. Alternatively, or in addition, in some embodiments, the conversion may include decoding the current video block from the bitstream.

The method 1300 enables selecting a motion shift from at least one motion shift list determined based on at least co-located frame. In this way, temporal motion information of the selected motion shift can be taken into consideration for the conversion. Coding effectiveness and coding efficiency can thus be improved.

In some embodiments, the MVP comprises at least one of: a temporal MVP (TMVP), or a subblock-based TMVP (SbTMVP).

In some embodiments, a candidate motion shift in the at least one motion shift list comprises a motion vector (MV) pointing to a co-located frame of the at least one co-located frame.

In some embodiments, the method 1300 further comprises: determining a candidate motion shift in the at least one motion shift list based on a coded block or a coded coding unit (CU).

In some embodiments, determining the candidate motion shift comprises: determining motion information of the coded block or coded CU; determining whether a motion vector (MV) associated with the motion information points to the at least one co-located frame; and adding the MV into the at least one motion shift list as the candidate motion shift.

In some embodiments, the MV is added into the at least one motion shift list after a redundancy check with a further candidate motion shift in the at least one motion shift list.

In some embodiments, the candidate motion shift comprises an adjacent candidate from a neighboring block or a neighbouring CU.

In some embodiments, the adjacent candidate is in at least one of: a predefined position or an adjacent position of the current video block.

In some embodiments, the candidate motion shift comprises a non-adjacent candidate from a non-neighbouring block or a non-neighbouring CU.

In some embodiments, the non-adjacent candidate is in at least one of: a predefined position or a non-adjacent position of the current video block.

In some embodiments, the candidate motion shift is from a motion vector (MV) list, the MV list comprising historical motion information of a coded block.

In some embodiments, the MV list comprises a history-based motion vector prediction (HMVP) list.

In some embodiments, the candidate motion shift comprises a virtual candidate.

In some embodiments, the virtual candidate comprises at least one of: a zero candidate or a constructed candidate.

In some embodiments, the candidate motion shift comprises a motion vector (MV) pointing to the at least one co-located frame.

In some embodiments, the candidate motion shift is determined by using at least one of the following coding modes: a regular mode, a combined inter and intra prediction (CIIP) coding tool, a merge with motion vector difference (MMVD) coding tool, a geometric partitioning mode (GPM) coding tool, or a triangle partition mode (TPM) coding tool.

In some embodiments, the method 1300 further comprises: performing a pruning process on the at least one motion shift list.

In some embodiments, the pruning process is performed based on a threshold to remove a redundant candidate motion shift in the at least one motion shift list.

In some embodiments, if at least one absolute difference between at least one component of a first candidate motion shift and at least one component of a second candidate motion shift is larger than or equal to a threshold difference, the first and second candidate motion shifts pointing to the at least one co-located frame, the first and second candidate motion shifts are included in the at least one motion shift list.

In some embodiments, the threshold difference is included in the bitstream.

In some embodiments, the threshold difference is included in at least one of: a prediction unit (PU), a coding unit (CU), a coding tree unit (CTU), or a slice level.

In some embodiments, the method 1300 further comprises: determining the threshold difference based on a characteristic of the current video block.

In some embodiments, the threshold difference is based on a diversity of candidate motion shifts of the current video block.

In some embodiments, the threshold difference is determined by a rate distortion optimization (RDO) process.

In some embodiments, the method 1300 further comprises: determining a subblock-based temporal MVP (SbTMVP) of the current video block based on the at least one motion shift list.

In some embodiments, the number of candidates in each of the at least one motion shift list is less than or equal to a threshold number.

In some embodiments, a first number of candidates are selected from a first motion shift list of the at least one motion shift list, and a second number of candidates are selected from a second motion shift list of the at least one motion shift list, the first and second numbers being the same or different.

In some embodiments, the number of the at least one motion shift list is based on the number of the at least one co-located frame.

In some embodiments, the number of the at least one motion shift list is the number of the at least one co-located frame.

In some embodiments, determining the at least one motion shift list comprises: for a co-located frame of the at least one co-located frame, adding a motion candidate associated with a motion vector (MV) in a reference list into a corresponding motion shift list of the at least one motion shift list, the MV pointing to the co-located frame.

In some embodiments, the motion candidate is added into the motion shift list after a redundancy check.

In some embodiments, the at least one motion shift list comprises a single motion shift list.

In some embodiments, determining the at least one motion shift list comprises: determining motion information of a candidate motion shift of the current video block; and in accordance with a determination that a motion vector (MV) in a reference picture list points to the at least one co-located frame, adding the candidate motion shift into one of the at least one motion shift list after a redundancy check, the MV being associated with the candidate motion shift.

In some embodiments, the method 1300 further comprises: sorting the at least one motion shift list based on a metric.

In some embodiments, the metric comprises at least one of: a template matching cost or a bilateral matching cost.

In some embodiments, a reference template locates in a co-located frame, a current template locates in a current frame, and a template matching cost is determined for at least a partial of candidate motion shifts in the at least one motion shift list.

In some embodiments, the at least one motion shift list is sorted based on template matching of candidate motion shifts in the at least one motion shift list.

In some embodiments, the method 1300 further comprises: performing at least one reordering process on the at least one motion shift list.

In some embodiments, the at least one reordering process is performed in a cascade way or in a parallel way.

In some embodiments, performing the at least one reordering process comprises: performing a first pass of reordering on candidates of a candidate type in the at least one motion shift list; and performing a second pass of reordering on candidates in the at least one motion shift list.

In some embodiments, a subblock-based temporal MVP (SbTMVP) candidate of the current video block is included in an MVP candidate list of a sub-coding unit (sub-CU) level.

In some embodiments, the SbTMVP candidate is determined based on at least a partial of the at least one motion shift list.

In some embodiments, the SbTMVP candidate is determined based on a set of candidates in the at least one motion shift list, the number of candidates in the set of candidates being less than or equal to a threshold number.

In some embodiments, the SbTMVP candidate is determined without using one of the at least one motions shift list.

In some embodiments, the method 1300 further comprises: determining at least one candidate in the at least one motion shift list based on respective metrics of candidates in the at least one motion shift list; and determining the SbTMVP candidate based on the at least one candidate.

In some embodiments, the at least one candidate comprises a first number of candidates from a first motion shift list of the at least one motion shift list and a second number of candidates from a second motion shift list of the at least one motion shift list, the first and second numbers being the same or different.

In some embodiments, determining the SbTMVP candidate comprises: comparing a first cost of a first candidate from the first motion shift lift with a second cost of a second candidate from the second motion shift list; and in accordance with a determination that the first cost is smaller than the second cost, determining the SbTMVP candidate based on the first candidate.

In some embodiments, the method 1300 further comprises: refining the target motion shift in the at least one motion shift list based on a template matching process; and determining the SbTMVP candidate based on the refined target motion shift.

In some embodiments, the SbTMVP candidate is determined based on the target motion shift in the at least one motion shift list without refining the target motion shift.

In some embodiments, the method 1300 further comprises: determining a further motion shift based on the at least one motion shift list.

In some embodiments, determining the further motion shift comprises: determining the further motion shift by averaging a plurality of motion shifts in the at least one motion shift list.

In some embodiments, the method 1300 further comprises: reordering the further motion shift with a plurality of motion shifts in the at least one motion shift list.

In some embodiments, the further motion shift satisfies a predefined condition, and the further motion shift is used to determine a subblock-based temporal MVP (SbTMVP) candidate of the current video block.

In some embodiments, the method 1300 further comprises: determining a subblock-based temporal MVP (SbTMVP) candidate of the current video block based on the target motion shift in the at least one motion shift list; including the SbTMVP in an MVP candidate list of a sub-coding unit (sub-CU) level; and reordering the MVP candidate list based on a metric.

In some embodiments, the metric comprises one of: a template matching cost or a bilateral matching cost.

In some embodiments, reordering the MVP candidate list comprises: determining respective metrics of a plurality of SbTMVP candidates and a plurality of affine candidates in the MVP candidate list; and reordering at least a partial of the plurality of SbTMVP candidates and the plurality of affine candidates based on respective metrics in a descending or ascending order.

In some embodiments, at least a partial of the plurality of SbTMVP candidates is in front of or behind of at least a partial of the plurality of affine candidates.

In some embodiments, a partial of the plurality of SbTMVP candidates is reordered with the plurality of affine candidates, and at least one remaining SbTMVP candidate of the plurality of SbTMVP candidates is in a predefined position in the MVP candidate list.

In some embodiments, the method 1300 further comprises: determining to reorder an SbTMVP candidate of the plurality of SbTMVP candidates based on a co-located frame associated with the SbTMVP candidate.

In some embodiments, the method 1300 further comprises: determining to reorder an SbTMVP candidate of the plurality of SbTMVP candidates based on a priority of a co-located frame, the SbTMVP candidate being in the co-located frame.

In some embodiments, the priority of the co-located frame is based on a distance between the co-located frame and a current frame comprising the current video block.

In some embodiments, for a co-located frame with a priority higher than a threshold, an SbTMVP candidate associated with the co-located frame is not reordered.

In some embodiments, the SbTMVP candidate is in a position in the MVP candidate list.

In some embodiments, the position is predefined. By way of example, the position comprises a most front position.

In some embodiments, the method 1300 further comprises: determining to reorder an SbTMVP candidate of the plurality of SbTMVP candidates based on a rank of a motion shift in the at least one motion shift list, the SbTMVP candidate being associated with the motion shift.

In some embodiments, if the rank of the motion shift is higher than or lower than a threshold, the SbTMVP candidate is not reordered, and the SbTMVP candidate is in a predefined position of the MVP candidate list.

In some embodiments, the method 1300 further comprises: determining to reorder an SbTMVP candidate of the plurality of SbTMVP candidates based on a priority of a co-located frame and a rank of a motion shift in the at least one motion shift list, the SbTMVP candidate being in the co-located frame and being associated with the motion shift.

In some embodiments, if a priority of the co-located frame is higher than a threshold priority, and a rank of the motion shift is higher than a threshold rank, the SbTMVP is in a predefined position of the MVP candidate list without reordering the SbTMVP candidate.

In some embodiments, the method 1300 further comprises: refining the target motion shift; determining a position in the at least one co-located frame based on the refined target motion shift; and determining at least one of a temporal MVP (TMVP) or a subblock-based TMVP (SbTMVP) based on the position.

In some embodiments, the refining the target motion shift is based on at least one of: template matching or bilateral matching.

In some embodiments, refining the target motion shift comprises at least one of: adding a delta motion vector (MV) to the target motion shift; clipping the target motion shift; or shifting the target motion shift.

In some embodiments, determining the target motion shift comprises: determining a plurality of motion shifts from the at least one motion shift list; and determining the target motion shift based on the plurality of motion shifts.

In some embodiments, the method 1300 further comprises: determining a position in the at least one co-located frame based on the target motion shift; and determining at least one of a temporal MVP (TMVP) or a subblock-based TMVP (SbTMVP) based on the position.

In some embodiments, determining the target motion shift based on the plurality of motion shifts comprises one of: determining an average of the plurality of motion shifts as the target motion shift; determining a weighted average of the plurality of motion shifts as the target motion shift; determining a maximum one of the plurality of motion shifts as the target motion shift; determining a minimum one of the plurality of motion shifts as the target motion shift; or determining a middle one of the plurality of motion shifts as the target motion shift.

According to further embodiments of the present disclosure, a non-transitory computer-readable recording medium is provided. The non-transitory computer-readable recording medium stores a bitstream of a video which is generated by a method performed by an apparatus for video processing. In the method, at least one motion shift list of the current video block is determined based on at least one co-located frame of a current video block of the video. A target motion shift associated a motion vector prediction (MVP) of the current video block is determined based on the at least one motion shift list. The bitstream is generated based on the target motion shift.

According to still further embodiments of the present disclosure, a method for storing bitstream of a video is provided. In the method, at least one motion shift list of the current video block is determined based on at least one co-located frame of a current video block of the video. A target motion shift associated a motion vector prediction (MVP) of the current video block is determined based on the at least one motion shift list. The bitstream is generated based on the target motion shift. The bitstream is stored in a non-transitory computer-readable recording medium.

It is to be understood that the above method 1200 and/or method 1300 may be used in combination or separately. Any suitable combination of these methods may be applied. Scope of the present disclosure is not limited in this regard.

By using these methods 1200 and 1300 separately or in combination, the video coding process may be improved by using temporal motion information. In this way, the coding effectiveness and coding efficiency can be improved.

Implementations of the present disclosure can be described in view of the following clauses, the features of which can be combined in any reasonable manner.

Clause 1. A method for video processing, comprising: determining, for a conversion between a current video block of a video and a bitstream of the video, a plurality of co-located frames of the current video block, the current video block being in a current frame co-located with the plurality of co-located frame; and performing the conversion based on the plurality of co-located frames.

Clause 2. The method of clause 1, wherein performing the conversion comprises: determining at least one motion vector (MV) associated with at least one of the plurality of co-located frames; and performing the conversion based on the at least one MV.

Clause 3. The method of clause 1 or clause 2, wherein the plurality of co-located frames comprises reconstructed frames in a decoding picture buffer (DPB).

Clause 4. The method of any of clauses 1-3, wherein the plurality of co-located frames comprises reconstructed frames in a reference list.

Clause 5. The method of any of clauses 1-4, wherein the plurality of co-located frames is selected from at least one reference list associated with the current frame.

Clause 6. The method of any of clauses 1-5, wherein the plurality of co-located frames comprises a first reference frame with a first index in a first reference list and a second reference frame with the first index in a second reference list, the first and second reference frames are different.

Clause 7. The method of clause 6, wherein a first picture order count (POC) value of the first reference frame is different from a second POC value of the second reference frame.

Clause 8. The method of any of clauses 1-7, wherein determining the plurality of co-located frames comprises: for a reference list in a plurality of candidate reference lists, selecting at least one candidate reference frame from the reference list based on indexes of reference frames in the reference list; and adding the at least one candidate reference frame into the plurality of co-located frames based on a comparison between the at least one candidate reference frame and a further co-located frames in the plurality of co-located frames.

Clause 9. The method of any of clauses 1-7, wherein determining the plurality of co-located frames comprises: adding a reference frame in a reference list into the plurality of co-located frames.

Clause 10. The method of any of clauses 1-4, wherein determining the plurality of co-located frames comprises: selecting a reference list from at least one reference list of the current frame; and adding a reference frame in the selected reference list into the plurality of co-located frames.

Clause 11. The method of any of clauses 1-10, wherein contents in a first reference list of the current frame are same with contents in a second reference list of the current frame, and the plurality of co-located frames is selected from one of the first or second reference list.

Clause 12. The method of any of clauses 1-11, wherein determining the plurality of co-located frames comprises: determining a set of candidate frames in a decoding picture buffer (DPB) or a reference list; and selecting the plurality of co-located frames from the set of candidate frames.

Clause 13. The method of clause 12, wherein selecting the plurality of co-located frames from the set of candidate frames comprises: adding a candidate frame from the set of candidate frames into the plurality of co-located frames based on a metric, the metric being associated with at least one of the following: a picture order count (POC) distance between the candidate frame and the current frame, or a quantization parameter (QP) value of the candidate frame.

Clause 14. The method of clause 13, wherein if the POC distance between the candidate frame and the current frame is smaller than a threshold distance, the candidate frame is added into the plurality of co-located frames.

Clause 15. The method of clause 13, wherein if the POC distance between the candidate frame and the current frame is larger than a threshold distance, the candidate frame is added into the plurality of co-located frames.

Clause 16. The method of any of clauses 13-15, wherein selecting the plurality of co-located frames from the set of candidate frames comprises: sorting the set of candidate frames based on POC distances between the set of candidate frames and the current frame in an ascending order; and selecting the plurality of co-located frames based on the sorting.

Clause 17. The method of any of clauses 13-16, wherein if an absolute QP distance between the candidate frame and the current frame is smaller than a threshold distance, the candidate frame is added into the plurality of co-located frames.

Clause 18. The method of any of clauses 13-16, wherein if an absolute QP distance between the candidate frame and the current frame is larger than a threshold distance, the candidate frame is added into the plurality of co-located frames.

Clause 19. The method of any of clauses 13-18, wherein selecting the plurality of co-located frames from the set of candidate frames comprises: sorting the set of candidate frames based on absolute QP distances between the set of candidate frames and the current frame in a descending order or an ascending order; and selecting the plurality of co-located frames based on the sorting.

Clause 20. The method of any of clauses 13-19, wherein selecting the plurality of co-located frames from the set of candidate frames comprises: sorting the set of candidate frames based on QP values of the set of candidate frames in an ascending order; and selecting the plurality of co-located frames based on the sorting.

Clause 21. The method of any of clauses 13-20, wherein a first POC distance between a first candidate frame in the set of candidate frames and the current frame is equal to a second POC distance between a second candidate frame in the set of candidate frames and the current frame, and wherein the first candidate frame is added into the plurality of co-located frames if at least one of the following conditions is met: a first QP value of the first candidate frame is larger than a second QP value of the second candidate frame, or a first absolute QP distance between the first candidate frame and the current frame is larger than a second absolute QP distance between the second candidate frame and the current frame.

Clause 22. The method of any of clauses 13-20, wherein a first POC distance between a first candidate frame in the set of candidate frames and the current frame is equal to a second POC distance between a second candidate frame in the set of candidate frames and the current frame, and wherein the first candidate frame is added into the plurality of co-located frames if at least one of the following conditions is met: a first QP value of the first candidate frame is smaller than a second QP value of the second candidate frame, or a first absolute QP distance between the first candidate frame and the current frame is smaller than a second absolute QP distance between the second candidate frame and the current frame.

Clause 23. The method of any of clauses 13-22, wherein a first QP value of a first candidate frame in the set of candidate frames is equal to a second QP value of a second candidate frame in the set of candidate frames, and wherein the first candidate frame is added into the plurality of co-located frames if at least one of the following conditions is met: a first POC distance between the first candidate frame and the current frame is larger than a second POC distance between the second candidate frame and the current frame, or a first absolute QP distance between the first candidate frame and the current frame is larger than a second absolute QP distance between the second candidate frame and the current frame.

Clause 24. The method of any of clauses 13-22, wherein a first QP value of a first candidate frame in the set of candidate frames is equal to a second QP value of a second candidate frame in the set of candidate frames, and wherein the first candidate frame is added into the plurality of co-located frames if at least one of the following conditions is met: a first POC distance between the first candidate frame and the current frame is smaller than a second POC distance between the second candidate frame and the current frame, or a first absolute QP distance between the first candidate frame and the current frame is smaller than a second absolute QP distance between the second candidate frame and the current frame.

Clause 25. The method of any of clauses 13-24, a first absolute QP distance between a first candidate frame in the set of candidate frames and the current frame is equal to a second absolute QP distance between a second candidate frame in the set of candidate frames and the current frame, and wherein the first candidate frame is added into the plurality of co-located frames if at least one of the following conditions is met: a first POC distance between the first candidate frame and the current frame is larger than a second POC distance between the second candidate frame and the current frame, or a first QP value of the first candidate frame is larger than a second QP value of the second candidate frame.

Clause 26. The method of any of clauses 13-24, a first absolute QP distance between a first candidate frame in the set of candidate frames and the current frame is equal to a second absolute QP distance between a second candidate frame in the set of candidate frames and the current frame, and wherein the first candidate frame is added into the plurality of co-located frames if at least one of the following conditions is met: a first POC distance between the first candidate frame and the current frame is smaller than a second POC distance between the second candidate frame and the current frame, or a first QP value of the first candidate frame is smaller than a second QP value of the second candidate frame.

Clause 27. The method of any of clauses 1-26, wherein information of the plurality of co-located frames is included in the bitstream.

Clause 28. The method of clause 27, wherein the information of the plurality of co-located frames is included in at least one of: a slice header, a sequence parameter set (SPS), a Picture Parameter Set (PPS), or a picture parameter header.

Clause 29. The method of clause 27 or clause 28, wherein the information of the plurality of co-located frames comprises: the number of co-located frames in the plurality of co-located frames.

Clause 30. The method of clause 29, wherein a plurality of indications of the plurality of co-located frames is included in the bitstream, the plurality of indications being subsequent to the number of co-located frames.

Clause 31. The method of any of clauses 27-30, wherein first information of a first co-located frame in the plurality of co-located frames is based on second information of a second co-located frame in the plurality of co-located frames, the first information being coded subsequent to the second information.

Clause 32. The method of any of clauses 27-31, wherein the information of the plurality of co-located frames is jointly coded.

Clause 33. The method of any of clauses 27-32, wherein a syntax element including information of at least one co-located frames in the plurality of co-located frames is binarized with at least one of the following: a fixed length coding tool, a unary coding tool, a truncated unary coding tool, or an Exponential Golomb coding tool.

Clause 34. The method of any of clauses 27-33, wherein if temporal motion vector prediction (TMVP) is enabled for the current frame, the information of the plurality of co-located frames is included in the bitstream.

Clause 35. The method of any of clauses 1-34, wherein a co-located frame in the plurality of co-located frames is indicated by at least one of: a reference list, or a reference index.

Clause 36. The method of any of clauses 1-35, further comprising: determining the plurality of co-located frames based on a predefined rule by an encoder and a decoder associated with the conversion.

Clause 37. The method of any of clauses 1-36, wherein priorities of the plurality of co-located frames are different.

Clause 38. The method of any of clauses 1-37, further comprising: determining a priority of a co-located frame of the plurality of co-located frames based on at least one of: a quantization parameter (QP) value of the co-located frame, or a temporal distance of the co-located frame relative to the current frame.

Clause 39. The method of any of clauses 1-38, wherein if a first quantization parameter (QP) value of a first co-located frame is larger than a second QP value of a second co-located frame, a first priority of the first co-located frame is higher than a second priority of the second co-located frame.

Clause 40. The method of any of clauses 1-38, wherein if a first quantization parameter (QP) value of a first co-located frame is smaller than a second QP value of a second co-located frame, a first priority of the first co-located frame is higher than a second priority of the second co-located frame.

Clause 41. The method of any of clauses 1-40, wherein if a first temporal distance between a first co-located frame and the current frame is smaller than a second temporal distance between a second co-located frame and the current frame, a first priority of the first co-located frame is higher than a second priority of the second co-located frame.

Clause 42. The method of any of clauses 1-40, wherein if a first temporal distance between a first co-located frame and the current frame is larger than a second temporal distance between a second co-located frame and the current frame, a first priority of the first co-located frame is higher than a second priority of the second co-located frame.

Clause 43. The method of any of clauses 1-42, wherein priorities of the plurality of co-located frames are associated with a video coding process.

Clause 44. The method of clause 43, wherein the video coding process comprises a temporal motion vector prediction (TMVP) constructure process.

Clause 45. The method of any of clauses 1-44, further comprising: determining a motion vector prediction (MVP) candidate list by traversing temporal MVPs (TMVPs) in the plurality of co-located frames based on a descending order of priorities of the plurality of co-located frames.

Clause 46. The method of clause 45, wherein the MVP candidate list comprises a TMVP candidate list.

Clause 47. The method of clause 45 or clause 46, wherein if the number of TMVPs in the MVP candidate list is larger than or equal to a threshold number, the traversing of the plurality of co-located frames is terminated.

Clause 48. The method of any of clauses 45-47, wherein determining the MVP candidate list comprises: for a co-located frame in the plurality of co-located frames, including a set of TMVP by checking a set of positions of the co-located frame in the MVP candidate list, the number of positions in the set of positions being larger than or equal to zero.

Clause 49. The method of clause 48, wherein the first position number of positions associated with a first co-located frame is different from the second number of positions associated with a second co-located frame.

Clause 50. The method of clause 48, wherein the first number of positions associated with a first co-located frame is same with the second number of positions associated with a second co-located frame.

Clause 51. The method of any of clauses 1-44, further comprising: determining a motion vector prediction (MVP) candidate list by traversing temporal MVPs (TMVPs) in a set of positions in the plurality of co-located frames based on an order of the set of positions, the number of positions in the set of positions being greater than or equal to zero.

Clause 52. The method of clause 51, wherein traversing TMVPs comprises: for a position in the set of positions, traversing TMVPs in the position in the plurality of co-located frames based on a descending order of priorities of the plurality of co-located frames.

Clause 53. The method of clause 52, wherein for the position in the set of positions, the number of TMVPs to be added in the MVP candidate list is less than or equal to a second threshold number.

Clause 54. The method of clause 53, wherein if the number of TMVPs corresponding to the position in the MVP candidate list is larger than or equal to the second threshold number, the traversing of the TMVPs in the position in the plurality of co-located frames is terminated.

Clause 55. The method of clause 52, wherein for the position in the set of positions, the number of TMVPs to be added in the MVP candidate list is larger than or equal to zero.

Clause 56. The method of any of clauses 51-55, wherein if the number of TMVPs in the MVP candidate list is larger than or equal to a third threshold number, the traversing of the TMVPS in the set of positions in the plurality of co-located frames is terminated.

Clause 57. The method of any of clauses 1-56, wherein a co-located frame with a priority lower than a priority threshold in the plurality of co-located frames is a backup co-located frame.

Clause 58. The method of clause 57, wherein if temporal motion vector prediction or information in a further co-located frame with a priority higher than the priority threshold does not exist, the backup co-located frame is activated.

Clause 59. The method of any of clauses 1-58, wherein first information for a position in a first co-located frame in the plurality of co-located frames is available, and the first information is used in the conversion.

Clause 60. The method of clause 59, wherein second information for the position in a second co-located frame in the plurality of co-located frames is not used, a priority of the second co-located frame is lower than a priority of the first co-located frame.

Clause 61. The method of clause 60, wherein the first information is not available, and the second information is used in the conversion.

Clause 62. The method of clause 59, wherein second information for the position in a second co-located frame in the plurality of co-located frames is used in the conversion, a priority of the second co-located frame is lower than a priority of the first co-located frame.

Clause 63. The method of any of clauses 59-62, wherein the first or second information comprises a temporal motion vector prediction (TMVP).

Clause 64. The method of any of clauses 1-36, wherein priorities of the plurality of co-located frames are the same.

Clause 65. The method of clause 64, further comprising: determining a set of candidate temporal motion vector predictions (TMVPs) located in the plurality of co-located frames; sorting the set of candidate TMVPs in a predetermined order; and determining at least one TMVPs from the set of candidate TMVPs based on the sorting.

Clause 66. The method of clause 65, wherein the predetermined order is based on a template matching cost.

Clause 67. The method of any of clauses 1-66, further comprising: determining at least one temporal motion vector prediction (TMVP) in at least one of the plurality of co-located frames.

Clause 68. The method of clause 67, further comprising: adding the at least one TMVP into a candidate list, the number of the at least one TMVP being less than or equal to a first threshold number.

Clause 69. The method of any of clause 68, wherein the number of TMVP associated with a co-located frame of the plurality of co-located frames in the candidate list is less than or equal to a second threshold number.

Clause 70. The method of any of clause 69, wherein at least one of the first threshold number or the second threshold number is predefined or determined during the conversion.

Clause 71. The method of any of clauses 68-70, wherein the candidate list comprises one of: a motion vector prediction (MVP) candidate list or a TMVP candidate list.

Clause 72. The method of any of clauses 68-71, wherein determining the candidate list comprises: determining the at least one TMVP by traversing the plurality of co-located frames based on an order, the order being predefined or determined during the conversion.

Clause 73. The method of clause 72, wherein for a first co-located frame in the plurality of co-located frames, the number of TMVPs to be added into the at least one TMVP is less than or equal to a third threshold number.

Clause 74. The method of clause 73, wherein for a second co-located frame in the plurality of co-located frames, the number of TMVPs to be added into the at least one TMVP is less than or equal to a fourth threshold number, the fourth threshold number being different from the third threshold number.

Clause 75. The method of any of clauses 72-74, wherein the traversing the plurality of co-located frames is terminated if the number of TMVPs added into the candidate list is larger than or equal to the first threshold number.

Clause 76. The method of any of clauses 68-75, wherein the first threshold number is included in the bitstream.

Clause 77. The method of clause 76, wherein the first threshold number is included in at least one of the following: a sequence parameter set (SPS), a picture parameter set (PPS), a picture header, or a slice header.

Clause 78. The method of any of clauses 1-77, wherein the plurality of co-located frames is used by a coding tool during the conversion, the coding tool comprising at least one of: a regular coding tool, a combined inter and intra prediction (CIIP) coding tool, a merge with motion vector difference (MMVD) coding tool, a geometric partitioning mode (GPM) coding tool, a triangle partition mode (TPM) coding tool, a subblock merge coding tool, an advanced motion vector prediction (AMVP) coding tool, an affine coding tool, or an adaptive decoder side motion vector refinement (DMVR) coding tool.

Clause 79. The method of any of clauses 1-78, further comprising: selecting a first set of temporal motion vector predictions (TMVPs) from a set of co-located frames in the plurality of co-located frames.

Clause 80. The method of clause 79, wherein a first number of TMVPs from a first co-located frame in the set of co-located frames is added into the first set of TMVPs, and a second number of TMVPs from a second co-located frame in the set of co-located frames is added into the first set of TMVPs, the first number being equal to or different from the second number.

Clause 81. The method of any of clauses 1-80, further comprising: determining at least one temporal motion vector prediction (TMVP) candidate list; and determining a motion vector prediction (MVP) list based on at least a partial of the at least one TMVP candidate list.

Clause 82. The method of clause 81, wherein determining the at least one TMVP candidate list comprises: determining a plurality of TMVP candidate list corresponding to the plurality of co-located frames, a TMVP candidate list in the plurality of TMVP candidate list comprising at least a partial of TMVP candidates in a respective co-located frame.

Clause 83. The method of clause 81, wherein determining the at least one TMVP candidate list comprises: determining a TMVP candidate list by adding at least a partial of TMVP candidates in the plurality of co-located frames.

Clause 84. The method of any of clauses 81-83, wherein determining the MVP list comprises: sorting the at least one TMVP candidate list based on a metric; and determining the MVP list based on the sorting.

Clause 85. The method of clause 84, wherein the metric comprises at least one of the following: a template matching cost, or a distance between a TMVP candidate and the current video block.

Clause 86. The method of clause 84 or clause 85, wherein determining the MVP list based on the sorting comprises: adding a first number of TMVPs in a first TMVP candidate list of the at least one TMVP candidate list into the MVP list; and adding a second number of TMVPs in a second TMVP candidate list of the at least one TMVP candidate list into the MVP list.

Clause 87. The method of clause 86, wherein the first TMVP candidate list is associated with a first co-located frame in the plurality of co-located frames, and the second TMVP candidate list is associated with a second co-located frame in the plurality of co-located frames.

Clause 88. The method of clause 86 or clause 87, wherein the first and second numbers are different or the same.

Clause 89. The method of any of clauses 1-88, further comprising: determining a motion vector prediction (MVP) list by adding a plurality of temporal MVPs (TMVPs) associated with at least one position in the plurality of co-located frames into the MVP list.

Clause 90. The method of any of clauses 1-89, further comprising: determining a set of temporal motion vector predictions (TMVPs) based on at least a partial of the plurality of co-located frames; adding the set of TMVPs in a joint candidate group, the joint candidate group further comprising a candidate of a further candidate type; and determining a merge candidate list from the joint candidate group based on a metric.

Clause 91. The method of clause 90, wherein the further candidate type comprises at least one of the following: a type of adjacent candidate, a type of non-adjacent candidate, a type of history-based motion vector predictor (HMVP) candidate, a type of zero candidate, or a type of constructed candidate.

Clause 92. The method of clause 90 or clause 91, wherein the metric comprises at least one of: a template matching cost, or a bilateral matching cost.

Clause 93. The method of any of clauses 1-92, further comprising: determining a first temporal motion vector prediction (TMVP) from a first co-located frame of the plurality of co-located frames; determining a second TMVP from a second co-located frame of the plurality of co-located frames; and determining a prediction of the current video block based on the first and second TMVPs.

Clause 94. The method of clause 93, wherein determining the prediction comprises: determining the prediction based on an average or a weighted average of the first and second TMVPs.

Clause 95. The method of clause 93 or clause 94, further comprising: determining a motion vector (MV) or a motion vector prediction (MVP) of the current video block based on an average or a weighted average of the first and second TMVPs.

Clause 96. A method for video processing, comprising: determining, for a conversion between a current video block of a video and a bitstream of the video, at least one motion shift list of the current video block based on at least one co-located frame of the current video block; determining a target motion shift associated a motion vector prediction (MVP) of the current video block based on the at least one motion shift list; and performing the conversion based on the target motion shift.

Clause 97. The method of clause 96, wherein the MVP comprises at least one of: a temporal MVP (TMVP), or a subblock-based TMVP (SbTMVP).

Clause 98. The method of clause 96 or clause 97, wherein a candidate motion shift in the at least one motion shift list comprises a motion vector (MV) pointing to a co-located frame of the at least one co-located frame.

Clause 99. The method of any of clauses 96-98, further comprising: determining a candidate motion shift in the at least one motion shift list based on a coded block or a coded coding unit (CU).

Clause 100. The method of clause 99, wherein determining the candidate motion shift comprises: determining motion information of the coded block or coded CU; determining whether a motion vector (MV) associated with the motion information points to the at least one co-located frame; and adding the MV into the at least one motion shift list as the candidate motion shift.

Clause 101. The method of clause 100, wherein the MV is added into the at least one motion shift list after a redundancy check with a further candidate motion shift in the at least one motion shift list.

Clause 102. The method of clause 99, wherein the candidate motion shift comprises an adjacent candidate from a neighboring block or a neighbouring CU.

Clause 103. The method of clause 102, wherein the adjacent candidate is in at least one of: a predefined position or an adjacent position of the current video block.

Clause 104. The method of clause 99, wherein the candidate motion shift comprises a non-adjacent candidate from a non-neighbouring block or a non-neighbouring CU.

Clause 105. The method of clause 104, wherein the non-adjacent candidate is in at least one of: a predefined position or a non-adjacent position of the current video block.

Clause 106. The method of clause 99, wherein the candidate motion shift is from a motion vector (MV) list, the MV list comprising historical motion information of a coded block.

Clause 107. The method of clause 106, wherein the MV list comprises a history-based motion vector prediction (HMVP) list.

Clause 108. The method of any of clauses 99-107, wherein the candidate motion shift comprises a virtual candidate.

Clause 109. The method of clause 108, wherein the virtual candidate comprises at least one of: a zero candidate or a constructed candidate.

Clause 110. The method of any of clauses 99-109, wherein the candidate motion shift comprises a motion vector (MV) pointing to the at least one co-located frame. Clause 111. The method of any of clauses 99-110, wherein the candidate motion shift is determined by using at least one of the following coding modes: a regular mode, a combined inter and intra prediction (CIIP) coding tool, a merge with motion vector difference (MMVD) coding tool, a geometric partitioning mode (GPM) coding tool, or a triangle partition mode (TPM) coding tool.

Clause 112. The method of any of clauses 96-111, further comprising: performing a pruning process on the at least one motion shift list.

Clause 113. The method of clause 112, wherein the pruning process is performed based on a threshold to remove a redundant candidate motion shift in the at least one motion shift list.

Clause 114. The method of any of clauses 96-113, wherein if at least one absolute difference between at least one component of a first candidate motion shift and at least one component of a second candidate motion shift is larger than or equal to a threshold difference, the first and second candidate motion shifts pointing to the at least one co-located frame, the first and second candidate motion shifts are included in the at least one motion shift list.

Clause 115. The method of clause 113 or clause 114, wherein the threshold difference is included in the bitstream.

Clause 116. The method of clause 115, wherein the threshold difference is included in at least one of: a prediction unit (PU), a coding unit (CU), a coding tree unit (CTU), or a slice level.

Clause 117. The method of any of clauses 113-116, further comprising: determining the threshold difference based on a characteristic of the current video block.

Clause 118. The method of any of clauses 113-117, wherein the threshold difference is based on a diversity of candidate motion shifts of the current video block.

Clause 119. The method of any of clauses 113-118, wherein the threshold difference is determined by a rate distortion optimization (RDO) process.

Clause 120. The method of any of clauses 96-119, further comprising: determining a subblock-based temporal MVP (SbTMVP) of the current video block based on the at least one motion shift list.

Clause 121. The method of clause 120, wherein the number of candidates in each of the at least one motion shift list is less than or equal to a threshold number.

Clause 122. The method of clause 120 or clause 121, wherein a first number of candidates are selected from a first motion shift list of the at least one motion shift list, and a second number of candidates are selected from a second motion shift list of the at least one motion shift list, the first and second numbers being the same or different.

Clause 123. The method of any of clauses 96-122, wherein the number of the at least one motion shift list is based on the number of the at least one co-located frame.

Clause 124. The method of clause 123, wherein the number of the at least one motion shift list is the number of the at least one co-located frame.

Clause 125. The method of clause 123 or clause 124, wherein determining the at least one motion shift list comprises: for a co-located frame of the at least one co-located frame, adding a motion candidate associated with a motion vector (MV) in a reference list into a corresponding motion shift list of the at least one motion shift list, the MV pointing to the co-located frame.

Clause 126. The method of clause 125, wherein the motion candidate is added into the motion shift list after a redundancy check.

Clause 127. The method of any of clauses 96-122, wherein the at least one motion shift list comprises a single motion shift list.

Clause 128. The method of any of clauses 96-127, wherein determining the at least one motion shift list comprises: determining motion information of a candidate motion shift of the current video block; and in accordance with a determination that a motion vector (MV) in a reference picture list points to the at least one co-located frame, adding the candidate motion shift into one of the at least one motion shift list after a redundancy check, the MV being associated with the candidate motion shift.

Clause 129. The method of any of clauses 96-128, further comprising: sorting the at least one motion shift list based on a metric.

Clause 130. The method of clause 129, wherein the metric comprises at least one of: a template matching cost or a bilateral matching cost.

Clause 131. The method of clause 129 or clause 130, wherein a reference template locates in a co-located frame, a current template locates in a current frame, and a template matching cost is determined for at least a partial of candidate motion shifts in the at least one motion shift list.

Clause 132. The method of any of clauses 129-131, wherein the at least one motion shift list is sorted based on template matching of candidate motion shifts in the at least one motion shift list.

Clause 133. The method of any of clauses 129-132, further comprising: performing at least one reordering process on the at least one motion shift list.

Clause 134. The method of clause 133, wherein the at least one reordering process is performed in a cascade way or in a parallel way.

Clause 135. The method of clause 133 or clause 134, wherein performing the at least one reordering process comprises: performing a first pass of reordering on candidates of a candidate type in the at least one motion shift list; and performing a second pass of reordering on candidates in the at least one motion shift list.

Clause 136. The method of any of clauses 96-135, wherein a subblock-based temporal MVP (SbTMVP) candidate of the current video block is included in an MVP candidate list of a sub-coding unit (sub-CU) level.

Clause 137. The method of clause 136, wherein the SbTMVP candidate is determined based on at least a partial of the at least one motion shift list.

Clause 138. The method of clause 136 or clause 137, wherein the SbTMVP candidate is determined based on a set of candidates in the at least one motion shift list, the number of candidates in the set of candidates being less than or equal to a threshold number.

Clause 139. The method of clause 136, wherein the SbTMVP candidate is determined without using one of the at least one motions shift list.

Clause 140. The method of any of clauses 136-139, further comprising: determining at least one candidate in the at least one motion shift list based on respective metrics of candidates in the at least one motion shift list; and determining the SbTMVP candidate based on the at least one candidate.

Clause 141. The method of clause 140, wherein the at least one candidate comprises a first number of candidates from a first motion shift list of the at least one motion shift list and a second number of candidates from a second motion shift list of the at least one motion shift list, the first and second numbers being the same or different.

Clause 142. The method of clause 141, wherein determining the SbTMVP candidate comprises: comparing a first cost of a first candidate from the first motion shift lift with a second cost of a second candidate from the second motion shift list; and in accordance with a determination that the first cost is smaller than the second cost, determining the SbTMVP candidate based on the first candidate.

Clause 143. The method of any of clauses 136-142, further comprising: refining the target motion shift in the at least one motion shift list based on a template matching process; and determining the SbTMVP candidate based on the refined target motion shift.

Clause 144. The method of any of clauses 136-142, wherein the SbTMVP candidate is determined based on the target motion shift in the at least one motion shift list without refining the target motion shift.

Clause 145. The method of any of clauses 136-144, further comprising: determining a further motion shift based on the at least one motion shift list.

Clause 146. The method of clause 145, wherein determining the further motion shift comprises: determining the further motion shift by averaging a plurality of motion shifts in the at least one motion shift list.

Clause 147. The method of clause 145 or clause 146, further comprising: reordering the further motion shift with a plurality of motion shifts in the at least one motion shift list.

Clause 148. The method of any of clauses 145-147, wherein the further motion shift satisfies a predefined condition, and the further motion shift is used to determine a subblock-based temporal MVP (SbTMVP) candidate of the current video block.

Clause 149. The method of any of clauses 96-147, further comprising: determining a subblock-based temporal MVP (SbTMVP) candidate of the current video block based on the target motion shift in the at least one motion shift list; including the SbTMVP in an MVP candidate list of a sub-coding unit (sub-CU) level; and reordering the MVP candidate list based on a metric.

Clause 150. The method of clause 149, wherein the metric comprises one of: a template matching cost or a bilateral matching cost.

Clause 151. The method of clause 149 or clause 150, wherein reordering the MVP candidate list comprises: determining respective metrics of a plurality of SbTMVP candidates and a plurality of affine candidates in the MVP candidate list; and reordering at least a partial of the plurality of SbTMVP candidates and the plurality of affine candidates based on respective metrics in a descending or ascending order.

Clause 152. The method of clause 151. wherein at least a partial of the plurality of SbTMVP candidates is in front of or behind of at least a partial of the plurality of affine candidates.

Clause 153. The method of clause 151 or clause 152, wherein a partial of the plurality of SbTMVP candidates is reordered with the plurality of affine candidates, and at least one remaining SbTMVP candidate of the plurality of SbTMVP candidates is in a predefined position in the MVP candidate list.

Clause 154. The method of any of clauses 151-153, further comprising: determining to reorder an SbTMVP candidate of the plurality of SbTMVP candidates based on a co-located frame associated with the SbTMVP candidate.

Clause 155. The method of any of clauses 151-154, further comprising: determining to reorder an SbTMVP candidate of the plurality of SbTMVP candidates based on a priority of a co-located frame, the SbTMVP candidate being in the co-located frame.

Clause 156. The method of clause 155, wherein the priority of the co-located frame is based on a distance between the co-located frame and a current frame comprising the current video block.

Clause 157. The method of any of clauses 154-156, wherein for a co-located frame with a priority higher than a threshold, an SbTMVP candidate associated with the co-located frame is not reordered.

Clause 158. The method of clause 157, wherein the SbTMVP candidate is in a position in the MVP candidate list.

Clause 159. The method of clause 158, wherein the position is predefined.

Clause 160. The method of clause 159, wherein the position comprises a most front position.

Clause 161. The method of any of clauses 151-153, further comprising: determining to reorder an SbTMVP candidate of the plurality of SbTMVP candidates based on a rank of a motion shift in the at least one motion shift list, the SbTMVP candidate being associated with the motion shift.

Clause 162. The method of clause 161, wherein if the rank of the motion shift is higher than or lower than a threshold, the SbTMVP candidate is not reordered, and the SbTMVP candidate is in a predefined position of the MVP candidate list.

Clause 163. The method of any of clauses 151-153, further comprising: determining to reorder an SbTMVP candidate of the plurality of SbTMVP candidates based on a priority of a co-located frame and a rank of a motion shift in the at least one motion shift list, the SbTMVP candidate being in the co-located frame and being associated with the motion shift.

Clause 164. The method of clause 163, wherein if a priority of the co-located frame is higher than a threshold priority, and a rank of the motion shift is higher than a threshold rank, the SbTMVP is in a predefined position of the MVP candidate list without reordering the SbTMVP candidate.

Clause 165. The method of any of clauses 96-164, further comprising: refining the target motion shift; determining a position in the at least one co-located frame based on the refined target motion shift; and determining at least one of a temporal MVP (TMVP) or a subblock-based TMVP (SbTMVP) based on the position.

Clause 166. The method of clause 165, wherein the refining the target motion shift is based on at least one of: template matching or bilateral matching.

Clause 167. The method of clause 165 or clause 166, wherein refining the target motion shift comprises at least one of: adding a delta motion vector (MV) to the target motion shift; clipping the target motion shift; or shifting the target motion shift.

Clause 168. The method of any of clauses 96-164, wherein determining the target motion shift comprises: determining a plurality of motion shifts from the at least one motion shift list; and determining the target motion shift based on the plurality of motion shifts.

Clause 169. The method of clause 168, further comprising: determining a position in the at least one co-located frame based on the target motion shift; and determining at least one of a temporal MVP (TMVP) or a subblock-based TMVP (SbTMVP) based on the position.

Clause 170. The method of clause 168 or clause 169, wherein determining the target motion shift based on the plurality of motion shifts comprises one of: determining an average of the plurality of motion shifts as the target motion shift; determining a weighted average of the plurality of motion shifts as the target motion shift; determining a maximum one of the plurality of motion shifts as the target motion shift; determining a minimum one of the plurality of motion shifts as the target motion shift; or determining a middle one of the plurality of motion shifts as the target motion shift.

Clause 171. The method of any of clauses 1-170, wherein the conversion includes encoding the current video block into the bitstream.

Clause 172. The method of any of clauses 1-170, wherein the conversion includes decoding the current video block from the bitstream.

Clause 173. An apparatus for video processing comprising a processor and a non-transitory memory with instructions thereon, wherein the instructions upon execution by the processor, cause the processor to perform a method in accordance with any of clauses 1-172.

Clause 174. A non-transitory computer-readable storage medium storing instructions that cause a processor to perform a method in accordance with any of clauses 1-172.

Clause 175. A non-transitory computer-readable recording medium storing a bitstream of a video which is generated by a method performed by an apparatus for video processing, wherein the method comprises: determining a plurality of co-located frames of a current video block of the video, the current video block being in a current frame co-located with the plurality of co-located frames; and generating the bitstream based on the plurality of co-located frames.

Clause 176. A method for storing a bitstream of a video, comprising: determining a plurality of co-located frames of a current video block of the video, the current video block being in a current frame co-located with the plurality of co-located frames; generating the bitstream based on the plurality of co-located frames; and storing the bitstream in a non-transitory computer-readable recording medium.

Clause 177. A non-transitory computer-readable recording medium storing a bitstream of a video which is generated by a method performed by an apparatus for video processing, wherein the method comprises: determining at least one motion shift list of the current video block based on at least one co-located frame of a current video block of the video; determining a target motion shift associated a motion vector prediction (MVP) of the current video block based on the at least one motion shift list; and generating the bitstream based on the target motion shift.

Clause 178. A method for storing a bitstream of a video, comprising: determining at least one motion shift list of the current video block based on at least one co-located frame of a current video block of the video; determining a target motion shift associated a motion vector prediction (MVP) of the current video block based on the at least one motion shift list; generating the bitstream based on the target motion shift; and storing the bitstream in a non-transitory computer-readable recording medium.

### Example Device

FIG. 14 illustrates a block diagram of a computing device 1400 in which various embodiments of the present disclosure can be implemented. The computing device 1400 may be implemented as or included in the source device 110 (or the video encoder 114 or 200) or the destination device 120 (or the video decoder 124 or 300).

It would be appreciated that the computing device 1400 shown in FIG. 14 is merely for purpose of illustration, without suggesting any limitation to the functions and scopes of the embodiments of the present disclosure in any manner.

As shown in FIG. 14, the computing device 1400 includes a general-purpose computing device 1400. The computing device 1400 may at least comprise one or more processors or processing units 1410, a memory 1420, a storage unit 1430, one or more communication units 1440, one or more input devices 1450, and one or more output devices 1460.

In some embodiments, the computing device 1400 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1400 can support any type of interface to a user (such as “wearable” circuitry and the like).

The processing unit 1410 may be a physical or virtual processor and can implement various processes based on programs stored in the memory 1420. In a multi-processor system, multiple processing units execute computer executable instructions in parallel so as to improve the parallel processing capability of the computing device 1400. The processing unit 1410 may also be referred to as a central processing unit (CPU), a microprocessor, a controller or a microcontroller.

The computing device 1400 typically includes various computer storage medium. Such medium can be any medium accessible by the computing device 1400, including, but not limited to, volatile and non-volatile medium, or detachable and non-detachable medium. The memory 1420 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1430 may be any detachable or non-detachable medium and may include a machine-readable medium such as a memory, flash memory drive, magnetic disk or another other media, which can be used for storing information and/or data and can be accessed in the computing device 1400.

The computing device 1400 may further include additional detachable/non-detachable, volatile/non-volatile memory medium. Although not shown in FIG. 14, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 1440 communicates with a further computing device via the communication medium. In addition, the functions of the components in the computing device 1400 can be implemented by a single computing cluster or multiple computing machines that can communicate via communication connections. Therefore, the computing device 1400 can operate in a networked environment using a logical connection with one or more other servers, networked personal computers (PCs) or further general network nodes.

The input device 1450 may be one or more of a variety of input devices, such as a mouse, keyboard, tracking ball, voice-input device, and the like. The output device 1460 may be one or more of a variety of output devices, such as a display, loudspeaker, printer, and the like. By means of the communication unit 1440, the computing device 1400 can further communicate with one or more external devices (not shown) such as the storage devices and display device, with one or more devices enabling the user to interact with the computing device 1400, or any devices (such as a network card, a modem and the like) enabling the computing device 1400 to communicate with one or more other computing devices, if required. Such communication can be performed via input/output (I/O) interfaces (not shown).

In some embodiments, instead of being integrated in a single device, some or all components of the computing device 1400 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1400 may be used to implement video encoding/decoding in embodiments of the present disclosure. The memory 1420 may include one or more video coding modules 1425 having one or more program instructions. These modules are accessible and executable by the processing unit 1410 to perform the functionalities of the various embodiments described herein.

In the example embodiments of performing video encoding, the input device 1450 may receive video data as an input 1470 to be encoded. The video data may be processed, for example, by the video coding module 1425, to generate an encoded bitstream. The encoded bitstream may be provided via the output device 1460 as an output 1480.

In the example embodiments of performing video decoding, the input device 1450 may receive an encoded bitstream as the input 1470. The encoded bitstream may be processed, for example, by the video coding module 1425, to generate decoded video data. The decoded video data may be provided via the output device 1460 as the output 1480.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/we claim:

1. A method for video processing, comprising:
determining, for a conversion between a current video block of a video and a bitstream of the video, a plurality of co-located frames of the current video block, the current video block being in a current frame co-located with the plurality of co-located frames; and
performing the conversion based on the plurality of co-located frames.

2. The method of claim 1, wherein performing the conversion comprises:
determining at least one motion vector (MV) associated with at least one of the plurality of co-located frames; and
performing the conversion based on the at least one MV.

3. The method of claim 1, wherein the plurality of co-located frames comprises reconstructed frames in a decoding picture buffer (DPB).

4. The method of claim 1, wherein the plurality of co-located frames comprises reconstructed frames in a reference list.

5. The method of claim 1, wherein the plurality of co-located frames is selected from at least one reference list associated with the current frame.

6. The method of claim 1, wherein the plurality of co-located frames comprises a first reference frame with a first index in a first reference list and a second reference frame with the first index in a second reference list, the first and second reference frames are different.

7. The method of claim 6, wherein a first picture order count (POC) value of the first reference frame is different from a second POC value of the second reference frame.

8. The method of claim 1, wherein determining the plurality of co-located frames comprises:
for a reference list in a plurality of candidate reference lists, selecting at least one candidate reference frame from the reference list based on indexes of reference frames in the reference list; and
adding the at least one candidate reference frame into the plurality of co-located frames based on a comparison between the at least one candidate reference frame and a further co-located frames in the plurality of co-located frames.

9. The method of claim 1, wherein determining the plurality of co-located frames comprises:
adding a reference frame in a reference list into the plurality of co-located frames.

10. The method of claim 1, wherein determining the plurality of co-located frames comprises:
selecting a reference list from at least one reference list of the current frame; and
adding a reference frame in the selected reference list into the plurality of co-located frames.

11. The method of claim 1, wherein contents in a first reference list of the current frame are same with contents in a second reference list of the current frame, and the plurality of co-located frames is selected from one of the first or second reference list.

12. The method of claim 1, further comprising:
determining a set of temporal motion vector predictions (TMVPs) based on at least a partial of the plurality of co-located frames;
adding the set of TMVPs in a joint candidate group, the joint candidate group further comprising a candidate of a further candidate type; and
determining a merge candidate list from the joint candidate group based on a metric.

13. The method of claim 1, further comprising:
determining a first temporal motion vector prediction (TMVP) from a first co-located frame of the plurality of co-located frames;
determining a second TMVP from a second co-located frame of the plurality of co-located frames; and
determining a prediction of the current video block based on the first and second TMVPs.

14. The method of claim 13, wherein determining the prediction comprises:
determining the prediction based on an average or a weighted average of the first and second TMVPs.

15. The method of claim 13, further comprising:
determining a motion vector (MV) or a motion vector prediction (MVP) of the current video block based on an average or a weighted average of the first and second TMVPs.

16. The method of claim 1, wherein the conversion includes encoding the current video block into the bitstream.

17. The method of claim 1, wherein the conversion includes decoding the current video block from the bitstream.

18. An apparatus for video processing comprising a processor and a non-transitory memory with instructions thereon, wherein the instructions upon execution by the processor, cause the processor to perform:
determine, for a conversion between a current video block of a video and a bitstream of the video, a plurality of co-located frames of the current video block, the current video block being in a current frame co-located with the plurality of co-located frames; and
perform the conversion based on the plurality of co-located frames.

19. A non-transitory computer-readable storage medium storing instructions that cause a processor to perform:
determine, for a conversion between a current video block of a video and a bitstream of the video, a plurality of co-located frames of the current video block, the current video block being in a current frame co-located with the plurality of co-located frames; and
perform the conversion based on the plurality of co-located frames.

20. A non-transitory computer-readable recording medium storing a bitstream of a video which is generated by a method performed by a video processing apparatus, wherein the method comprises:
determining a plurality of co-located frames of a current video block of the video, the current video block being in a current frame co-located with the plurality of co-located frames; and
generating the bitstream based on the plurality of co-located frames.
